(19) United States
(12) Patent Application Publication
(10) Pub. No.: US 2025/0350757 A1
(43) Pub. Date: Nov. 13, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Yang WANG, Beijing (CN); Kai ZHANG, Los Angeles, CA (US); Li ZHANG, Los Angeles, CA (US)

(21) Appl. No.: 19/274,382

(22) Filed: Jul. 18, 2025

Related U.S. Application Data
(63) Continuation of application No. PCT/CN2024/072864, filed on Jan. 17, 2024.

(30) Foreign Application Priority Data
Jan. 19, 2023 (WO) PCT/CN2023/073261

(51) Int. Cl. H04N 19/51; H04N 19/14; H04N 19/176

(52) U.S. Cl. CPC H04N 19/51; H04N 19/14; H04N 19/176

(57) ABSTRACT

Embodiments of the disclosure provide a solution for video processing. A method for video processing is proposed. The method includes: determining, for a conversion between a video unit of a video and a bitstream of the video, whether an intra block copy (IBC) and local illumination compensation (LIC) (IBC-LIC) is applied to the video unit based on a model used for the IBC-LIC; in accordance with a determination that the IBC-LIC is applied to the video unit, performing a compensation process to a prediction/reconstruction of the video unit using a model of the IBC-LIC; and performing the conversion based on the compensated prediction/reconstruction of the video unit.

### CROSS REFERENCE

This application is a continuation of International Application No. PCT/CN2024/072864, filed on Jan. 17, 2024, which claims the benefit of International Application No. PCT/CN2023/073261, filed on Jan. 19, 2023. The entire contents of these applications are hereby incorporated by reference in their entireties.

### FIELDS

Embodiments of the present disclosure relates generally to video processing techniques, and more particularly, to intra block copy with local illumination compensation.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video, whether an intra block copy (IBC) and local illumination compensation (LIC) (IBC-LIC) is applied to the video unit; in accordance with a determination that the IBC-LIC is applied to the video unit, performing a compensation process to a prediction/reconstruction of the video unit using a model of the IBC-LIC; and performing the conversion based on the compensated prediction/reconstruction of the video unit. In this way, it can improve coding efficiency.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining whether an intra block copy (IBC) and local illumination compensation (LIC) (IBC-LIC) is applied to a video unit of the video; in accordance with a determination that the IBC-LIC is applied to the video unit, performing a compensation process to a prediction/reconstruction of the video unit using a model of the IBC-LIC; and generating the bitstream based on the compensated prediction/reconstruction of the video unit.

In a fifth aspect, a method for storing a bitstream of a video is proposed. The method comprises: determining whether an intra block copy (IBC) and local illumination compensation (LIC) (IBC-LIC) is applied to a video unit of the video; in accordance with a determination that the IBC-LIC is applied to the video unit, performing a compensation process to a prediction/reconstruction of the video unit using a model of the IBC-LIC; generating the bitstream based on the compensated prediction/reconstruction of the video unit; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example of encoder block diagram of VVC;

FIG. 5 illustrates several intra prediction modes;

FIG. 6A and FIG. 6B illustrate reference samples for wide-angular intra prediction;

FIG. 7 illustrates problem of discontinuity in case of directions beyond 45°;

FIG. 8 illustrates example of motion vector scaling for temporal merge candidate;

FIG. 9A and FIG. 9B illustrate MMVD search point;

FIG. 10 illustrates an example of local illustration compensation;

FIG. 11 illustrates no subsampling for the short side;

FIG. 12 illustrates IBC reference region depending on current CU position;

FIG. 13 illustrates examples of symmetry in screen content pictures;

FIG. 14A illustrates an illustration of BV adjustment for horizontal flip;

FIG. 14B illustrates an illustration of BV adjustment for vertical flip;

FIG. 15 illustrates an intra template matching search area used;

FIG. 16 illustrates templates used to derive the parameters of LIC for IBC;

FIG. 17 illustrates samples used to drive IBC-LIC parameters for the templates;

FIG. 18 illustrates adjusted reference template when RR-IBC is horizontal flip;

FIG. 19 illustrates adjusted reference template when RR-IBC is vertical flip;

FIG. 20 illustrates a flowchart of a method for video processing in accordance with embodiments of the present disclosure; and

FIG. 21 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

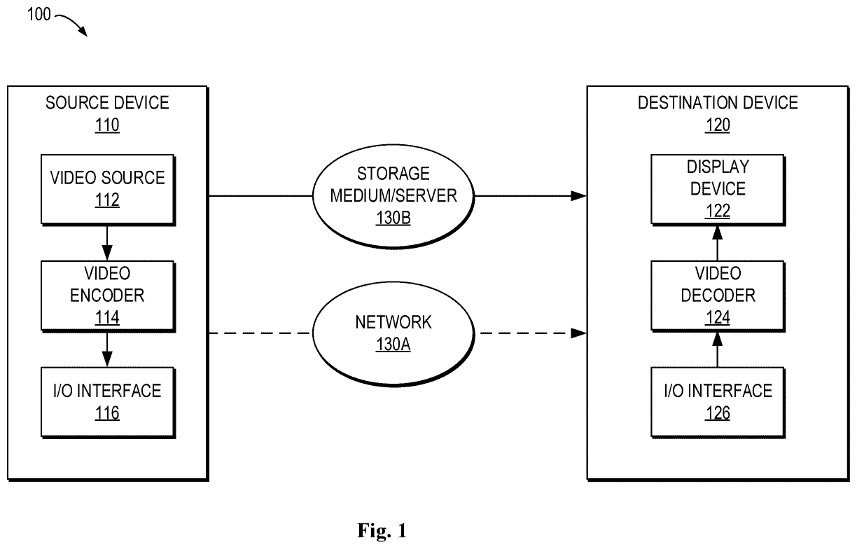

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

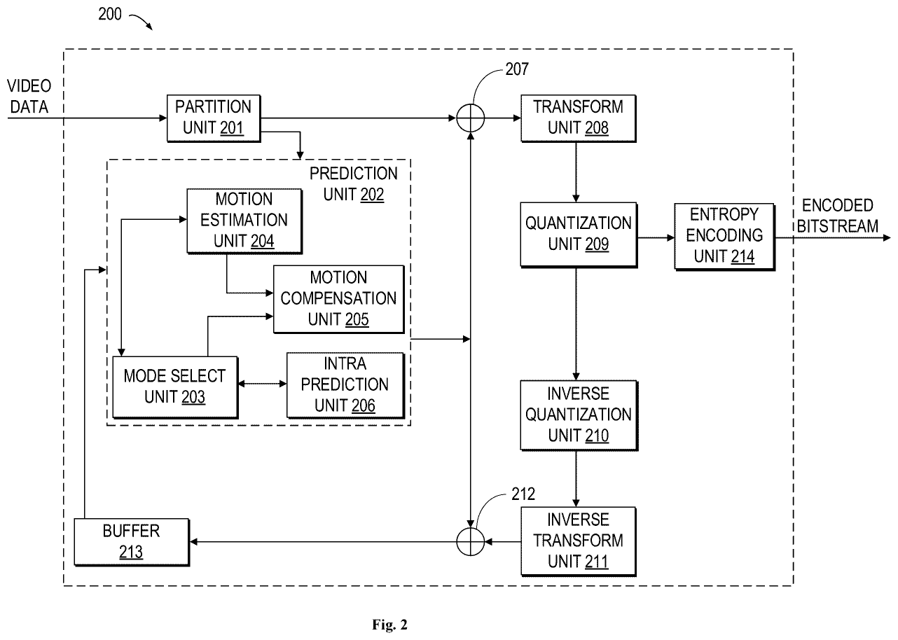

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

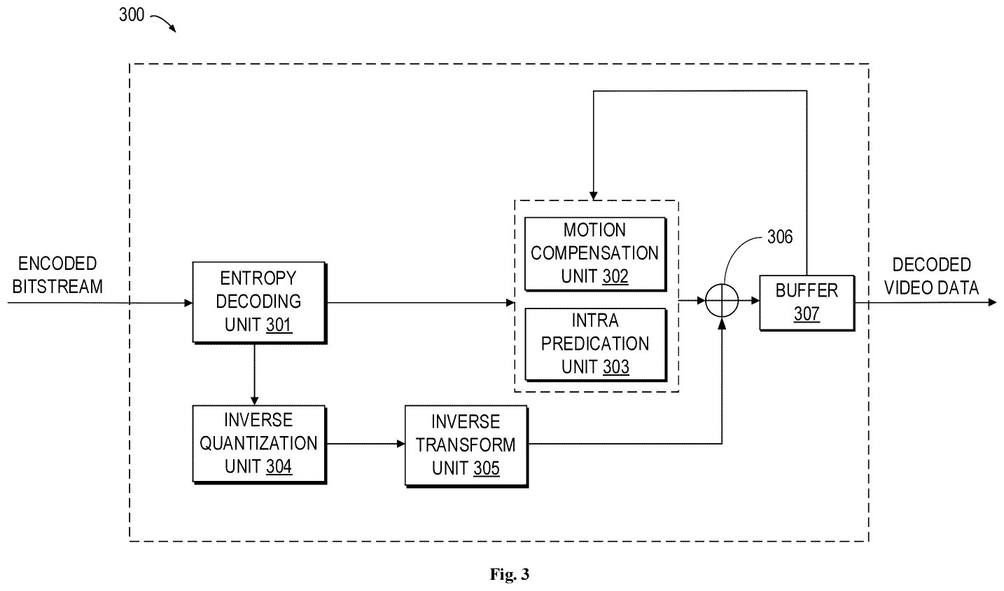

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

The present disclosure is related to video coding technologies. Specifically, it is related to intra block copy (IBC), how to and/or whether to combine IBC with local illumination compensation, and other coding tools in image/video coding. It may be applied to the existing video coding standard like HEVC, or Versatile Video Coding (VVC). It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC.

### 2.1 Coding Flow of a Typical Video Codec

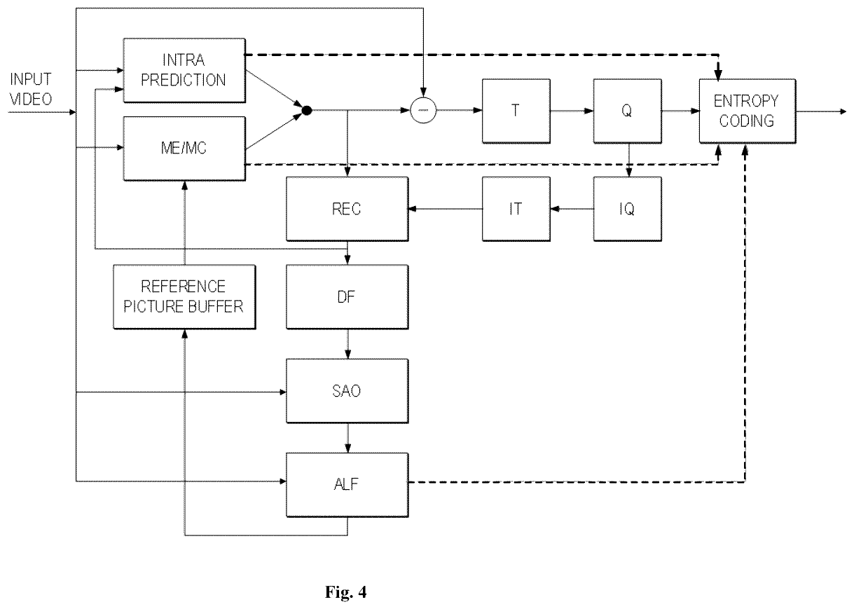

FIG. 4 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

2.2 Intra Mode Coding with 67 Intra Prediction Modes

FIG. 5 illustrates 67 intra prediction modes. To capture the arbitrary edge directions presented in natural video, the number of directional intra modes is extended from 33, as used in HEVC, to 65, as shown in FIG. 5, and the planar and DC modes remain the same. These denser directional intra prediction modes apply for all block sizes and for both luma and chroma intra predictions.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.2.1 Wide Angle Intra Prediction

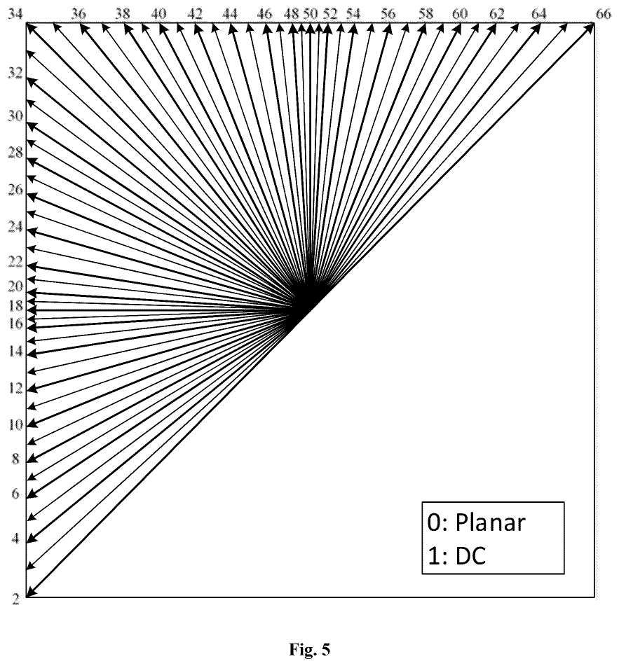

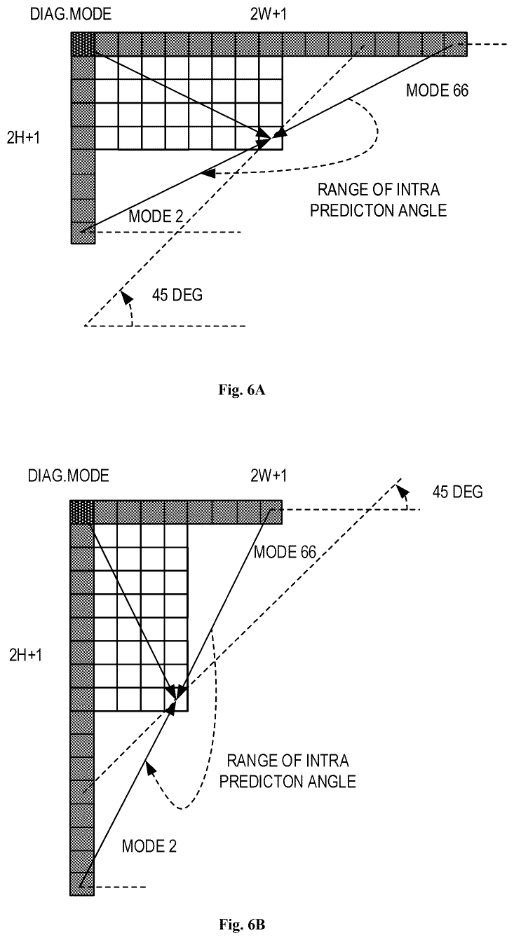

Although 67 modes are defined in the VVC, the exact prediction direction for a given intra prediction mode index is further dependent on the block shape. Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged. FIG. 6A and FIG. 6B illustrate reference samples for wide-angular intra prediction To support these prediction directions, the top reference with length 2W+1, and the left reference with length 2H+1, are defined as shown in FIG. 6A and FIG. 6B. FIG. 6A and FIG. 6B illustrate reference samples for wide-angular intra prediction.

The number of replaced modes in wide-angular direction mode depends on the aspect ratio of a block. The replaced intra prediction modes are illustrated in Table 1.

TABLE 1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, |
| | 65, 66 |

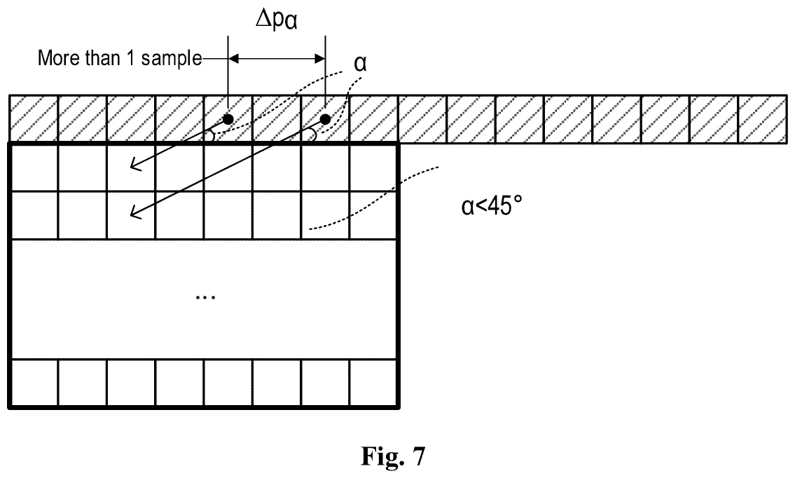

As shown in FIG. 7, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below-135 degree and above 45 degree, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### 2.3 Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 2.4 Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signalled as IBC AMVP mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.
   2.5 Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

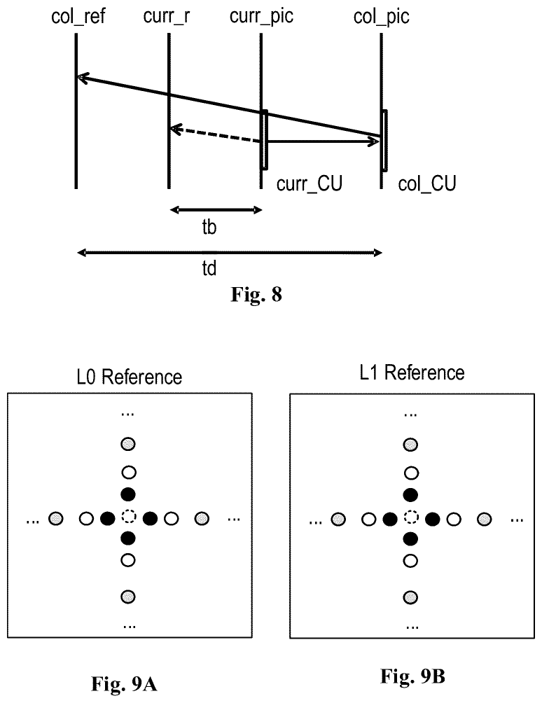

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates. FIG. 8 shows an illustration of motion vector scaling for temporal merge candidate.

FIG. 9A and FIG. 9B illustrate examples of MMVD search point. Distance index specifies motion magnitude information and indicate the pre-defined offset from the starting point. As shown in FIG. 9A and FIG. 9B, an offset is added to either horizontal component or vertical component of starting MV. The relation of distance index and pre-defined offset is specified in Table 2.

TABLE 2
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 3. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 3 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign in Table 3 specifies the sign of MV offset added to the list0 MV component of starting MV and the sign for the list1 MV has opposite value. Otherwise, if the difference of POC in list 1 is greater than list 0, the sign in Table 3 specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb, described in FIG. 8. If the POC difference of L1 is greater than L0, the MVD for list 0 is scaled in the same way. If the starting MV is uni-predicted, the MVD is added to the available MV.

TABLE 3
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 2.6 Local Illumination Compensation (LIC)

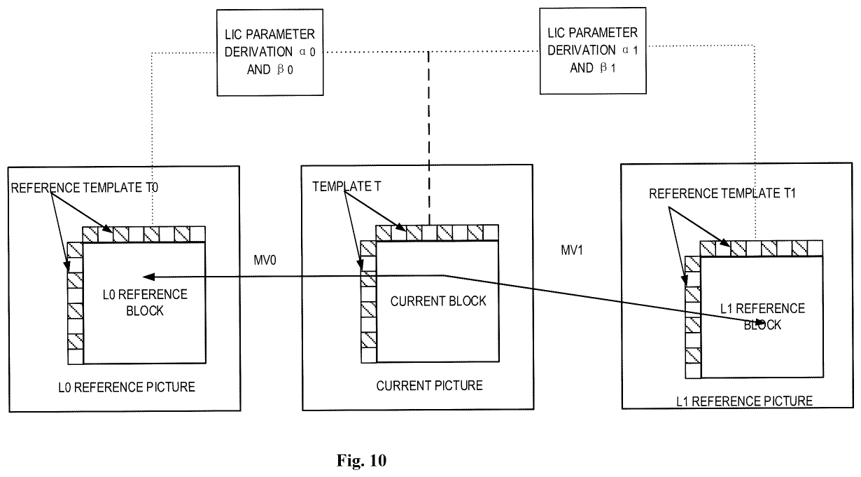

Local illumination compensation (LIC) is a coding tool to address the issue of local illumination changes between current picture and its temporal reference pictures. The LIC is based on a linear model where a scaling factor and an offset are applied to the reference samples to obtain the prediction samples of a current block. Specifically, the LIC can be mathematically modeled by the following equation:

$$P ( x , y ) = α \cdot {P}_{r} ( x + {v}_{x} , y + {v}_{y} ) + β$$

where P(x, y) is the prediction signal of the current block at the coordinate (x, y); Pᵣ(x+vₓ, y+v_{y}) is the reference block pointed by the motion vector (vₓ, v_{y}); α and β are the corresponding scaling factor and offset that are applied to the reference block. FIG. 10 illustrates the LIC process. FIG. 10 illustrates an example of local illustration compensation. In FIG. 10, when the LIC is applied for a block, a least mean square error (LMSE) method is employed to derive the values of the LIC parameters (i.e., α and β) by minimizing the difference between the neighboring samples of the current block (i.e., the template T in FIG. 10) and their corresponding reference samples in the temporal reference pictures (i.e., either T0 or T1 in FIG. 10). Additionally, to reduce the computational complexity, both the template samples and the reference template samples are subsampled (adaptive subsampling) to derive the LIC parameters, i.e., only the shaded samples in FIG. 10 are used to derive α and β.

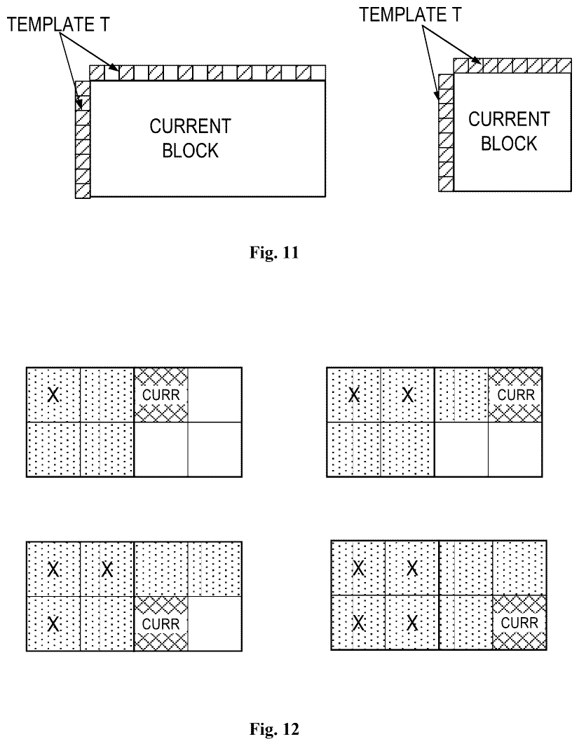

FIG. 11 illustrates no subsampling for the short side. To improve the coding performance, no subsampling for the short side is performed as shown in FIG. 11.

2.7 IBC with Template Matching

It is proposed to also use Template Matching with IBC for both IBC merge mode and IBC AMVP mode.

The IBC-TM merge list has been modified compared to the one used by regular IBC merge mode such that the candidates are selected according to a pruning method with a motion distance between the candidates as in the regular TM merge mode. The ending zero motion fulfillment (which is a nonsense regarding Intra coding) has been replaced by motion vectors to the left (−W, 0), top (0, −H) and top-left (−W, −H) CUs, then, if necessary, the list is fulfilled with the left one without pruning.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC merge list. Each of those 3 selected candidates are refined using the Template Matching method and sorted according to their resulting Template Matching cost. Only the 2 first ones are then considered in the motion estimation process as usual.

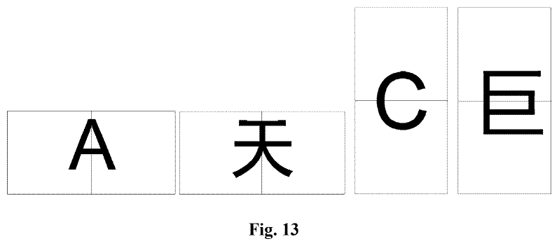

FIG. 12 illustrates IBC reference region depending on current CU position. The Template Matching refinement for both IBC-TM merge and AMVP modes is quite simple since IBC motion vectors are constrained to be integer and within a reference region as shown in FIG. 12. So, in IBC-TM merge mode, all refinements are performed at integer precision, and in IBC-TM AMVP mode, they are performed either at integer or 4-pel precision. In both cases, the refined motion vectors in each refinement step must respect the constraint of the reference region.

2.8 IBC Merge Mode with Block Vector Differences

IBC merge mode with block vector differences is shown as follows.

The distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding.

### 2.9 Reconstruction-Reordered IBC (RR-IBC)

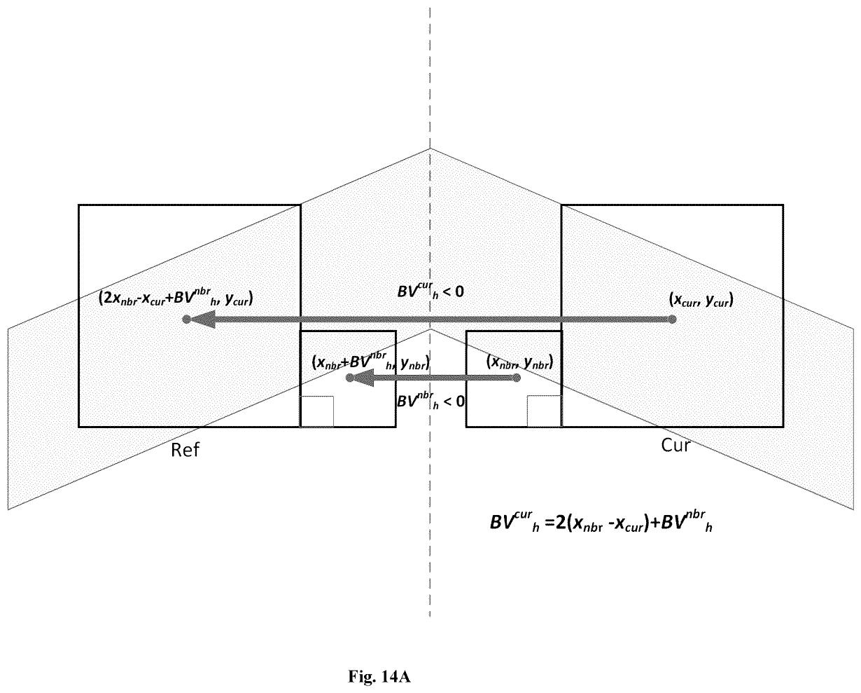

Screen content coding tools like Intra Block Copy (IBC) generate a prediction block by directly copying a prior coded reference region in the same picture. FIG. 13 illustrates examples of symmetry in screen content pictures. Symmetry is often observed in video content, especially in text character regions and computer-generated graphics in screen content sequences, as shown in FIG. 13. Therefore, a specific screen content coding tool considering the symmetry would be efficient to compress such kinds of video contents.

A Reconstruction-Reordered IBC (RR-IBC) mode is proposed for screen content video coding. When it is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

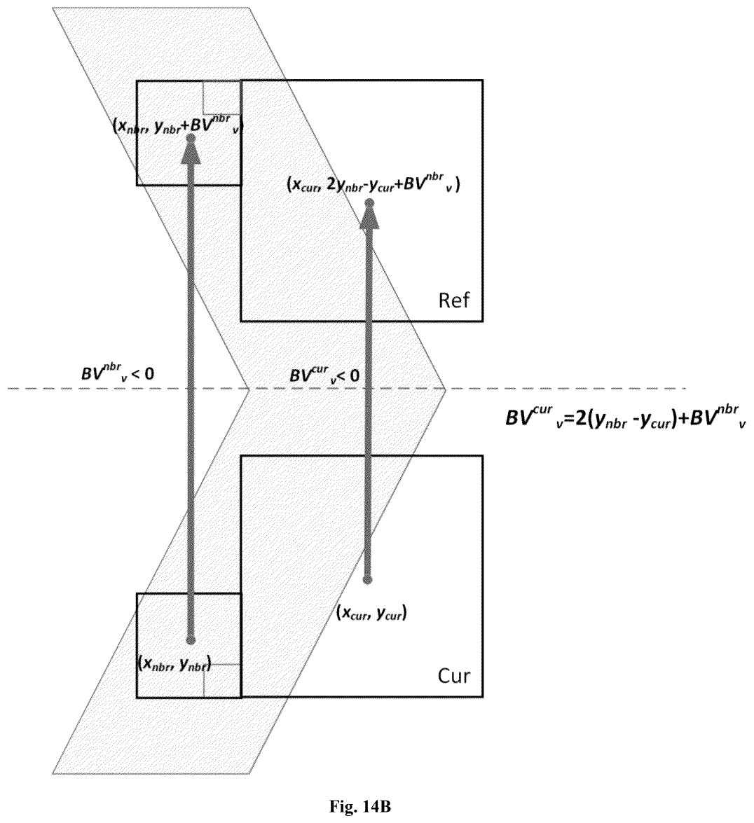

FIG. 14A illustrates an illustration of BV adjustment for horizontal flip. FIG. 14B illustrates an illustration of BV adjustment for vertical flip. To better utilize the symmetry property, a flip-aware BV adjustment approach is applied to refine the block vector candidate. For example, as shown in FIG. 14A and FIG. 14B, (x_{nbr}, y_{nbr}) and (x_{cur}, y_{cur}) represent the coordinates of the center sample of the neighboring block and the current block, respectively, BV^{nbr} and BV^{cur} denotes the BV of the neighboring block and the current block, respectively. Instead of directly inheriting the BV from a neighbouring block, the horizontal component of BV^{cur} is calculated by adding a motion shift to the horizontal component of BV^{nbr} (denoted as BV^{nbr}ₕ) in case that the neighbouring block is coded with a horizontal flip, i.e., BV^{cur}ₕ=2(x_{nbr}−x_{cur})+BV^{nbr}ₕ. Similarly, the vertical component of BV^{cur} is calculated by adding a motion shift to the vertical component of BV^{nbr} (denoted as BV^{nbr}ᵥ) in case that the neighbouring block is coded with a vertical flip, i.e., BV^{cur}ᵥ=2(y_{nbr}−y_{cur})+BV^{nbr}ᵥ.

### 2.10 Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

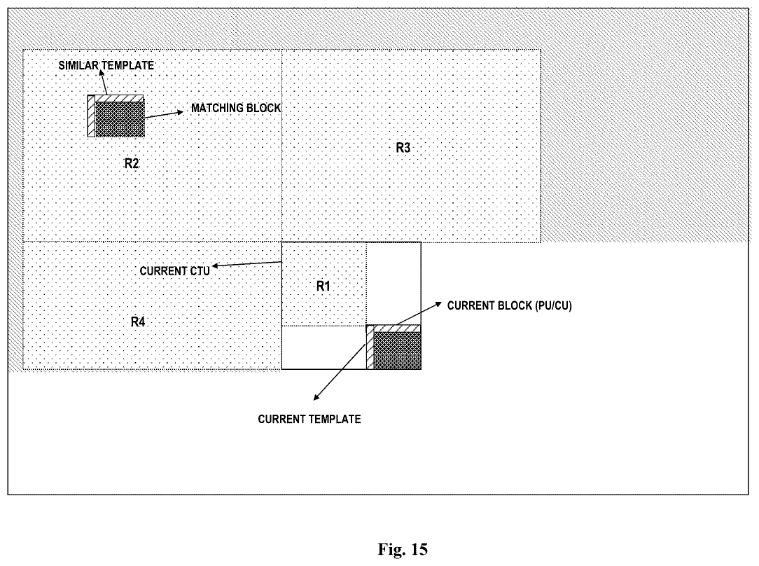

FIG. 15 illustrates an intra template matching search area used. The prediction signal is generated by matching the L-shaped causal neighbor of the current block with another block in a predefined search area in FIG. 15 consisting of:
R1: current CTU,
R2: top-left CTU,
R3: above CTU,
R4: left CTU.

SAD is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:
SearchRange_w=a*BlkW
SearchRange_h=a*BlkH
where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 3. Problems

In current design of IBC, the whole block is directly copied from the reconstructed region in the current picture. However, when illumination change occurs within the current picture, the coding efficiency of IBC may be limited.

### 4. Detailed Solutions

The detailed embodiments below should be considered as examples to explain general concepts. These embodiments should not be interpreted in a narrow way. Furthermore, these embodiments can be combined in any manner.

In the present disclosure, intra block copy (IBC) may not be limited to the current IBC technology, but may be interpreted as the technology that reference (or prediction) block is obtained with samples in the current slice/tile/subpicture/picture/other video unit (e.g., CTU row) excluding the conventional intra prediction methods. In the present disclosure, local illumination compensation (LIC) may not be limited to the current LIC technology. LIC may refer to an inter prediction technique to model local illumination variation between current block and its prediction block as a function of that between current block template and reference block template. The parameters of the function may be denoted by a linear equation (e.g., α×p[x]+β) or a non-linear equation. In the present disclosure, CIBCIP (or IBC-CIIP) may refer to a coding tool which combines of intra block copy (IBC) and intra prediction. It's a coding tool which obtain the prediction of a block using both IBC and intra prediction.

In the present disclosure, IBC-GPM may refer to a coding tool which obtains the prediction of at least one sub-partitions using IBC in a video unit when the video unit is divided into more than one sub-partitions geometrically. In the following discussion, IBC may be replaced by other coding tools that rely on coded/decoded/reconstructed information within the same region, e.g., palette, intra template matching.

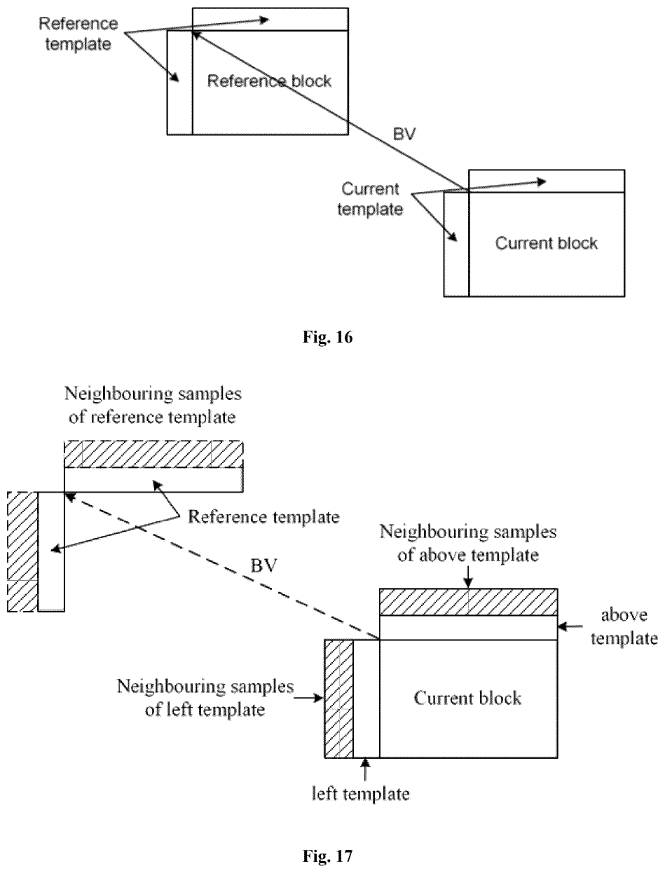

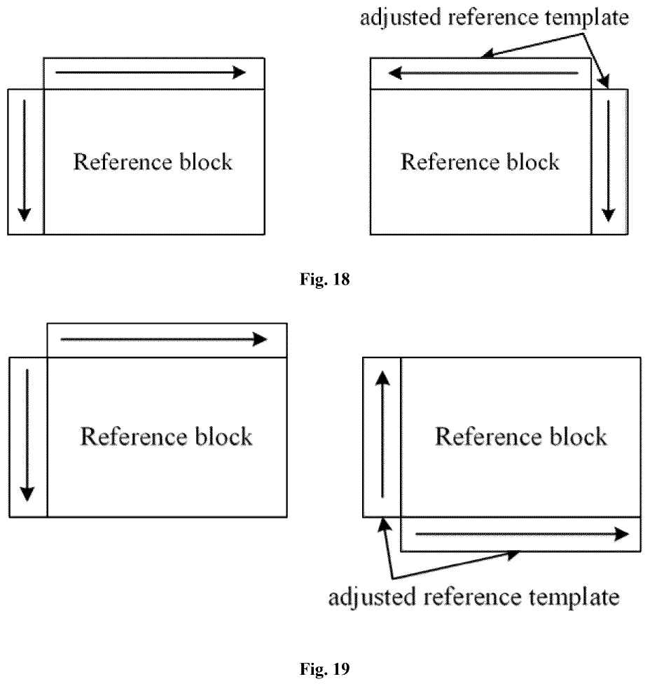

IBC with LIC
1. It is proposed that a refined prediction sample may be derived as f(p[x]), wherein p[x] denotes a prediction sample of the video unit, and f is any function.
   a. In one example, f(p[x])=α×p[x]+β, wherein α and β denotes the parameters of the linear equation.
   b. In one example, the function or at least one parameter of the function may be derived based on a template of the current block.
   c. In one example, the prediction sample may be derived by IBC.
      i. In one example, the function or at least one parameter of the function may be derived based on a template of the reference block of the current block, wherein the reference block may be located by a block vector (BV).
   d. In one example, one or more offsets may be used to modify one or more derived parameters.
      i. In one example, the one or more offsets may be signalled, or derived, or pre-defined.
      ii. In one example, whether to and/or how to use the offsets to modify one or more parameters may be signalled, or pre-defined, or determined using coding information.
2. It is proposed that LIC may be applied to compensate the prediction (reconstruction) of a video unit, wherein IBC is used to obtain the prediction (reconstruction) of the video unit. It is denoted as IBC-LIC.
   a. In one example, a linear or non-linear equation/model may be used for IBC-LIC to compensate the prediction of the video unit.
      i. In one example, the linear equation may be α×p[x]+β, wherein p[x] denotes the prediction of the video unit, and α and β denotes the parameters of the linear equation.
      ii. In one example, the equation may be c₀×x₀+c₁×x₁+c₂×x₂+ . . . +c_{N}×x_{N}+B, wherein cᵢ are the parameters and xᵢ denote the coding information.
         1) In one example, the information may refer coding to reconstruction/reference/prediction samples, or the values calculated using the reconstruction/reference/prediction samples (e.g., gradients), or position information of the reconstruction/reference/prediction samples.
   b. In one example, the parameters of the equation used in IBC-LIC may be pre-defined, or signalled in the bitstream.
   c. In one example, the parameters of the equation used in IBC-LIC may be derived using coding information.
      i. In one example, a current template consists of the neighbouring reconstructed (adjacent or non-adjacent) samples of the video unit and a reference template may be used to derive the parameters. An example is shown in FIG. 16.
         1) In one example, the reference template may be derived using the BV that is used to obtain the prediction of the video unit.
         a) In one example, when the BV is fractional BV, it may be rounded to an integer BV.
         i. In one example, clipping operation may be used when rounding the fractional BV.
         ii. Alternatively, the fractional BV is still used to derive the reference template.
         1. In one example, the same interpolation method is used to derive the reference template as the interpolation method used to derive the prediction of the video unit.
         2. Alternatively, a different interpolation method is used to derive the reference template as the interpolation method to used derive the prediction of the video unit, such as different interpolation taps.
         a. In one example, 2-tap interpolation filter may be used.
         2) In one example, partial or all samples of the current template and the reference template may be used to derive the parameters.
         3) In one example, a least square error method may be used to derive the parameters.
         4) In one example, the method solving a linear/non-linear equation (e.g., MSE minimization) used for other coding tools may be used to derive the parameters.
         a) In one example, the method may refer to Cholesky decomposition used in ALF and its variants.
         b) In one example, the method may refer to LDL decomposition used in CCCM and its variants.
         c) In one example, the method may refer to Gaussian elimination used in CCCM and its variants.
         5) In one example, MSE minimization may be used as the metric to solve the linear/non-linear equation.
         a) In one example, other metrics may be used to solve the linear/non-linear equation, such as SSE or mean of SSE.
         b) In one example, a subjective metric may be used to solve the linear/non-linear equation, such as SSIM.
      ii. In one example, how to derive the parameters using the current template and the reference template may be same as LIC for inter prediction.
      iii. In one example, more than one method may be used to derive the parameters for IBC-LIC.
         1) In one example, which method is used may signalled, or per-defined, or determined using coding information.
         2) In one example, more than one method may be used to derive more than one set of parameters, and the predictions of the current video unit modified using the more than one set of parameters may be fused.
         a) In one example, the weights used for fusion may be pre-defined, or signalled, or determined using coding information.
   d. In one example, partial or all prediction samples of the video unit may be compensated using IBC-LIC.
3. In one example, IBC-LIC may be applied to IBC AMVP mode and/or IBC merge mode.
   a. In one example, IBC AMVP mode may refer to normal IBC AMVP, or TM based IBC AMVP, or RR-IBC AMVP mode, or CIBCIP (IBC-CIIP), or IBC-GPM, or other IBC AMVP mode wherein a BV predictor is derived and BVD is signalled/derived.
   b. In one example, IBC merge mode may refer to normal IBC merge mode, or IBC-TM merge mode, or IBC-MBVD mode, or CIBCIP (IBC-CIIP), or IBC-GPM.
      i. In one example, IBC-LIC may be applied to a specific IBC merge candidate type.
      ii. In another example, IBC-LIC may be not allowed to apply to a specific IBC merge candidate type.
         1) In one example, the merge candidate type may refer to RR-IBC candidate.
   c. Alternatively, IBC-LIC may be not allowed to be applied to one or more of the above IBC coding tools.
      i. In one example, the IBC coding tool may refer to RR-IBC, or CIBCIP (IBC-CIIP), or IBC-GPM.
   d. In one example, whether to and/or how to apply IBC-LIC for IBC AMVP mode and/or IBC merge mode may be signalled or determined using coding information.
   e. In one example, one or more syntax elements may be signalled to indicate whether to and/or how to apply IBC-LIC for IBC AMVP mode and/or IBC merge mode.
   f. In one example, whether to and/or how to apply IBC-LIC for IBC merge mode may be inherited.
      i. In one example, the inheritance of whether to and/or how to apply IBC-LIC may be associated with the merge candidate.
         1) In one example, IBC-LIC may be disabled when a merge candidate is a specific merge type.
         a) In one example, the specific type may refer to RR-IBC.
      ii. In one example, whether to apply IBC-LIC for IBC merge mode may be derived.
         1) In one example, template matching based method may be used.
         a) In one example, a first cost (C₁) may be calculated between the prediction of the template of current video unit and its reconstruction when IBC-LIC is applied; a second cost (C₂) may be calculated between the prediction of the template of current video unit and its reconstruction when IBC-LIC is not applied.
         i. In one example, when C₁<=C₂, IBC-LIC may be applied; when C₁>C₂, IBC-LIC may be not applied.
         ii. In one example, when C₁<=S*C₂, IBC-LIC may be applied; when C₁>S*C₂, IBC-LIC may be not applied, wherein S is a scale factor.
         iii. In one example, when C₁<=C₂+O, IBC-LIC may be applied; when C₁>C₂+O, IBC-LIC may be not applied, wherein O is an offset.
4. In one example, IBC-LIC may be used in the process of reordering a BV candidate list.
   a. In one example, the BV candidate list may refer to IBC AMVP candidate list, and/or IBC merge candidate list.
      i. In one example, the BV candidate list may refer to IBC regular merge list, and/or IBC TM merge list, and/or IBC-MBVD merge list.
   b. In one example, two-pass reordering may be used to reorder the BV candidate list.
      i. In one example, IBC-LIC may be applied to in the first pass reordering, or the second pass reordering, or both of first pass and second pass reordering.
   c. In one example, whether to and/or how to apply IBC-LIC in the BV candidate list reordering process may be same as that applying IBC-LIC to the current video unit.
   d. In one example, when IBC-LIC is used for a BV candidate, the prediction of the template may be refined using the IBC-LIC model.
      i. In one example, the neighbouring reconstructed samples of the left/above template, and/or the neighbouring reconstructed samples of the reference template of the left/above template may be used to derive the IBC-LIC parameters. An example is shown in FIG. 17.
         1) In one example, the reference template of the left/above template may be derived using the BV associated with the BV candidate.
         2) In one example, the neighbouring reconstructed samples of the left/above template, and/or the neighbouring reconstructed samples of the reference template of the left/above template, and/or the left/above template may be constrained in the IBC buffer.
         3) In one example, when the neighbouring reconstructed samples of the left/above template, and/or the neighbouring reconstructed samples of the reference template of the left/above template, and/or the left/above template are out of the IBC buffer, IBC-LIC may be not used.
         a) Alternatively, when the neighbouring reconstructed samples of the left/above template, and/or the neighbouring reconstructed samples of the reference template of the left/above template, and/or the left/above template are out of the IBC buffer, the samples out of the IBC buffer may be padded using the samples in the IBC buffer and IBC-LIC may be used.
   e. In one example, IBC-LIC may be applied to one or more BV candidates in the BV candidate list.
      i. In one example, whether to apply IBC-LIC to a BV candidate may depend on the type of the BV candidate.
         1) In one example, the type of the BV candidate may refer to spatial BV candidate, or HMVP BV candidate, or pairwise BV candidate, or default BV candidate, or other types of BV candidate.
      ii. In one example, IBC-LIC may be applied to partial BV candidates in the list.
   f. In one example, when a BV candidate is RR-IBC (e.g., RR-IBC flip type is horizontal or vertical), IBC-LIC may be not used.
      i. Alternatively, IBC-LIC may be used.
         1) In one example, the original BV of the BV candidate may be used to derive the IBC-LIC parameters.
         2) In one example, the adjusted BV of the BV candidate according to the RR-IBC flip type may be used to derive the IBC-LIC parameters.
   g. In one example, a set of IBC-LIC parameters may be derived.
      i. In one example, the derived set of IBC-LIC parameters may be used for left and/or above template.
   h. In one example, multiple sets of IBC-LIC parameters may be derived.
      i. In one example, a first set of IBC-LIC parameters may be used for the left template.
      ii. In one example, a second set of IBC-LIC parameters may be used for the above template.
   i. In one example, whether to and/or how to apply IBC-LIC to the BV candidate list reordering may depend on a specific coding tool using the BV candidate list.
      i. In one example, IBC-LIC may be applied to the BV candidate list reordering when the coding tool is IBC AMVP mode, and/or IBC regular merge mode, and/or IBC TM merge mode, and/or IBC-MBVD merge mode.
      ii. Alternatively, IBC-LIC may be not applied to the BV candidate list reordering when the coding tool is IBC AMVP mode, and/or IBC regular merge mode, and/or IBC TM merge mode, and/or IBC-MBVD merge mode.
5. In one example, when RR-IBC is used, IBC-LIC may be used.
   a. In one example, the positions/shapes/of a template used for LIC may depend on whether RR-IBC is applied.
   b. In one example, the original BV without adjusted according to the RR-IBC flip type may be used to derive the IBC-LIC parameters.
   c. In one example, the adjusted BV according to the RR-IBC flip type may be used to derive the IBC-LIC parameters.
   d. In one example, the original template of the reference block may be used to derive the IBC-LIC parameters.
      i. In one example, the original template of the reference block may be constrained in the IBC buffer.
      ii. In one example, when the original template is not in the IBC buffer, IBC-LIC may be not used.
         1) Alternatively, when the original template is not in the IBC buffer, the original template may be padded using the samples in the IBC buffer and then used in IBC-LIC.
   e. In one example, the adjusted template of the reference block may be used to derive the IBC-LIC parameters.
      i. In one example, the adjusted template of the reference block may be constrained in the IBC buffer.
      ii. In one example, the adjusted template of the reference block may be adjusted according to the RR-IBC flip type.
         1) In one example, when RR-IBC flip type is horizontal, the adjusted left and above template of the reference template may be used. An example is shown in FIG. 18.
         2) In one example, when RR-IBC flip type is vertical, the adjusted left and above template of the reference template may be used. An example is shown in FIG. 19.
      iii. In one example, when the adjusted template is not in the IBC buffer, IBC-LIC may be not used.
         1) Alternatively, when the adjusted template is not in the IBC buffer, the adjusted template may be padded using the samples in the IBC buffer and then used in IBC-LIC.
   f. In one example, IBC-LIC may be used with a specific RR-IBC flip type.
      i. In one example, the flip type may be horizontal.
      ii. In one example, the flip type may be vertical.
6. In one example, whether to and/or how to apply IBC-LIC may depend on the coding information including:
   a. block dimensions and/or block size
      i. In one example, the block is allowed to be coded with IBC-LIC when the block size (W×H) is less than or equal to a threshold (T1), wherein W and H denotes block width and block height, respectively.
         1) In one example, T1=256, or 512, or 1024, or 2048, or 4096.
         2) In one example, T1 may depend on whether IBC AMVP mode or IBC merge mode is used.
         3) In one example, T1 may depend on slice/picture type.
      ii. In one example, the block is allowed to be coded with IBC-LIC when the block size (W×H) is larger than or equal to a threshold (T2), wherein W and H denotes block width and block height, respectively.
         1) In one example, T2=4, or 8, or 16, or 32, or 64, or 128, or 256.
         2) In one example, T2 may depend on whether IBC AMVP mode or IBC merge mode is used.
         3) In one example, T2 may depend on slice/picture type.
      iii. In one example, the block is allowed to be coded with IBC-LIC when the block size W and/or H is less than or equal to a threshold (T1′), wherein W and H denotes block width and block height, respectively.
         1) In one example, T1′=4, or 8, or 16, or 32, or 64, or 128, or 256.
         2) In one example, T1′ may depend on whether IBC AMVP mode or IBC merge mode is used.
         3) In one example, T1′ may depend on slice/picture type.
      iv. In one example, the block is allowed to be coded with IBC-LIC when the block size W and/or H is larger than or equal to a threshold (T2′), wherein W and H denotes block width and block height, respectively.
         1) In one example, T2′=4, or 8, or 16, or 32, or 64, or 128, or 256.
         2) In one example, T2′ may depend on whether IBC AMVP mode or IBC merge mode is used.
         3) In one example, T2′ may depend on slice/picture type.
      v. In one example, the block size may refer to luma block size.
      vi. In one example, the block size may refer to chroma block size.
   b. the coded information may refer to the depth of a block.
   c. slice/picture type and/or partition tree type (single, or dual tree, or local dual tree)
      i. In one example, IBC-LIC may be only applied to I slice/picture.
   d. block location
   e. quantization parameter
   f. colour component
7. In one example, more than one LIC equations may be used to compensate the prediction (reconstruction) of a video unit which is derived using IBC.
   a. In one example, the multiple LIC types may refer to different LIC equations with adjustment parameters for one or more existing parameters of LIC (e.g., α and β).
      i. In one example, an adjustment parameter may be used to adjust α, such as α+u or α×u.
      ii. In one example, an adjustment parameter may be used to adjust β, such as β+v or β×v.
   b. In one example, the parameters of more than one LIC equations may be derived using different templates.
      i. In one example, different sample lines of the template may be used.
      ii. In one example, left, or above, or left-above, left-below, above-right templates may be used.
      iii. In one example, the templates may be adjacent and/or non-adjacent.
      iv. In one example, samples from different positions in the template may be used.
         1) In one example, the positions may refer to down-sampling positions.
      v. In one example, samples in different categories may be used.
         1) In one example, the different categories may be classified depending on the samples of the template.
         2) In one example, a mean value of the samples in the template may be used to derive the different categories.
   c. In one example, more than one method may be used to derive the parameters for IBC-LIC.
      i. In one example, which method is used may signalled, or per-defined, or determined using coding information.
   d. In one example, more than one method and/or more than templates may be used to derive more than one set of parameters, wherein the prediction signals of the current blocks modified by using the more than one set of parameters may be fused.
      i. In one example, the weights used for fusion may be pre-defined, or signalled, or determined using coding information.
   e. In one example, whether to and how to apply one of the more than one LIC equations may be indicated using a syntax element which is signalled in the bitstream.
   f. In one example, whether to and how to apply one of the more than one LIC equations may be determined adaptively.
8. In one example, at least one parameter in an IBC-LIC equation and/or at least one IBC-LIC equation used for the video units coded/decoded before the current video unit may be reused for the current video unit.
   a. In one example, the video units coded/decoded before current video unit may be in a different slice/tile/picture/CTU/CTU row.
   b. In one example, the video units coded/decoded before current video unit may be in the same slice/tile/picture/CTU/CTU row as the current video unit.
   c. In one example, the video units coded/decoded before current video unit may be the neighbouring spatial (e.g., adjacent and/or non-adjacent) video units.
   d. In one example, the reused parameters may be stored in a list/table (e.g., HMVP IBC-LIC parameter table).
      i. In one example, the list/table may be updated during the coding/decoding process.
      ii. In one example, the maximum size of the list/table may be pre-defined, or signalled, or derived.
      iii. In one example, the list/table may be re-initialized at the beginning of a slice/tile/picture/CTU/CTU row.
         1) In one example, the list/table may be re-initialized as a void list/table.
         2) In one example, the list/table may be re-initialized using one or more pre-defined/derived/signalled parameters.
      iv. In one example, how to and/or whether to use/update the list/table may depend on coding information.
         1) In one example, the coding information may refer to block dimensions/size/position.
   e. In one example, when the current video unit is chroma video unit, the reused parameters may come from luma video unit and/or chroma video unit.
9. In one example, IBC-LIC may be applied to the sub-blocks within the current video unit.
   a. In one example, whether to and/or how to apply IBC-LIC to the sub-blocks may be pre-defined, or signalled, or determined.
      i. In one example, a syntax element may be used to indicate whether IBC-LIC is applied with sub-block level.
      ii. In one example, whether to and/or how to apply IBC-LIC to the sub-blocks may depend on block dimensions/size.
      iii. In one example, IBC-LIC may be applied to all sub-blocks or not applied to all sub-blocks.
      iv. In one example, IBC-LIC may be applied to partial sub-blocks and IBC-LIC may be not applied to the other sub-blocks.
         1) In one example, the partial sub-blocks to which IBC-LIC is applied to may be the boundary sub-blocks.
   b. In one example, the IBC-LIC parameters may be derived different for at least one sub-block.
   c. In one example, the IBC-LIC parameters may be shared by at least one sub-block.
10. In one example, the positions/shape of the template may depend on coding information.
   a. In one example, if the left neighboring samples are unavailable, the template only contains the above neighbouring samples.
   b. In one example, if the above neighboring samples are unavailable, the template only contains the left neighbouring samples.
   c. In one example, if the left and above neighboring samples are unavailable, IBC-LIC may not be applicable.
   d. In one example, the template may refer to the template of the current block or the reference block.
   e. In one example, the positions/shape of the template may depend on whether RR-IBC or normal IBC is applied.
   f. In one example, the positions/shape of the template may consist of one or more sample lines.
   g. In one example, the positions/shape of the template may be pre-defined, or signalled, or derived on-the-fly.
   h. In one example, the positions/shape of the template may depend on the width and height of the video unit.
   i. In one example, the reference template may be constrained in the IBC buffer.
      i. Alternatively, the reference template may be not constrained in the IBC buffer.
11. The determination of whether a block is allowed to be coded with IBC-LIC mode may depend on coded information including:
   a. block dimensions and/or block size.
      i. In one example, the block is allowed to be coded with IBC-LIC mode when the block size (W×H) is less than or equal to a threshold (T), wherein W and H denotes block width and block height, respectively.
         1) In one example, T=256, or 512, or 1024, or 2048, or 4096.
         2) In one example, T may depend on whether IBC AMVP mode or IBC merge mode is used.
      ii. In one example, the block is allowed to be coded with IBC-LIC when the block size (W×H) is larger than or equal to a threshold (T4), wherein W and H denotes block width and block height, respectively.
         1) In one example, T4=4, or 8, or 16, or 32, or 64, or 128, or 256, or 512, or 1024, or 2048.
         2) In one example, T4 may depend on whether IBC AMVP mode or IBC merge mode is used.
      iii. In one example, the block is allowed to be coded with IBC-LIC when the block size W and/or H is less than or equal to a threshold (T3′), wherein W and H denotes block width and block height, respectively.
         1) In one example, T3′=4, 8, 16, or 32, or 64, or 128, or 256.
         2) In one example, T3′ may depend on whether IBC AMVP mode or IBC merge mode is used.
      iv. In one example, the block is allowed to be coded with IBC-LIC when the block size W and/or H is larger than or equal to a threshold (T4′), wherein W and H denotes block width and block height, respectively.
         1) In one example, T4′=4, 8, 16, or 32, or 64, or 128, or 256.
         2) In one example, T4′ may depend on whether IBC AMVP mode or IBC merge mode is used.
      v. In above examples, T, T4, T3′, T4′ may depend on slice/picture type.
      vi. In one example, the block size may refer to luma block size.
      vii. In one example, the block size may refer to chroma block size.
   b. depth of a block.
   c. block location.
   d. slice/picture type.
   e. temporal layer (e.g., temporal layer index).
   f. colour format.
   g. colour component.
12. In one example, whether to and/or how to apply IBC-LIC may depend on colour format and/or colour components.
   a. In one example, IBC-LIC may apply to all colour components.
   b. In one example, whether to and/or how to apply IBC-LIC to a first component may depend on whether to apply IBC-LIC to a second component.
      i. In one example, the first component may refer to chroma component (e.g., Cb and/or Cr), and the second component may refer to luma component (e.g., Y).
      ii. In one example, the way to apply IBC-LIC to the first component may be same as the second component.
         1) Alternatively, the way to apply IBC-LIC to the first component may be different from the second component.
      iii. In one example, the determination of whether to and/or how to apply IBC-LIC to a first video unit in the first component may depend on a second video unit in the second component.
         1) In one example, the second video unit may be the collocated luma video unit of the first video unit.
         a) In one example, P_{L}(x, y)=P_{C}(x*SubWidthC, y*SubHeightC), Wherein P_{C} and P_{L} denote the positions of the first video unit and the second video unit respectively.
         b) In one example, (P_{C}(x, y)) may refer to the center position of the chroma video unit. Denote the width and height of the chroma video unit as W and H, and x is in the range of 0 and W−1, inclusive, and y is in the range of 0 and H−1, inclusive.
         i. In one example, (P_{C}(x, y))=(W/2−1, H/2+1).
         ii. In one example, (P_{C}(x, y))=(W/2+1, H/2−1).
         iii. In one example, (P_{C}(x, y))=(W/2−1, H/2+1).
         iv. In one example, (P_{C}(x, y))=(W/2+1, H/2+1).
         c) In one example, (P_{C}(x, y)) may refer to the left-top/right-top/left-bottom/right-bottom position of the chroma video unit.
         2) In one example, the second video unit may be the collocated luma video unit, or the spatial neighbouring (adjacent and/or non-adjacent) luma video units of the collocated luma video unit.
         a) In one example, the spatial neighbouring luma video units may refer to left, left-below, left-above, above, above-right neighbouring luma video units.
         b) In one example, the spatial neighbouring (adjacent and/or non-adjacent) luma video units of the collocated luma video unit may be used when the collocated luma video unit is not coded with IBC mode or IntraTMP mode.
         3) In one example, IBC-LIC may be applied to the first video unit when the second video unit is coded with IBC mode or IntraTMP mode.
   c. In one example, IBC-LIC may apply to luma component, but not to chroma components.
      i. In one example, luma component may refer to Y in YCbCr colour space or G in RGB colour space.
      ii. In one example, chroma components may refer to Cb and/or Cr in YCbCr colour space or R and/or B in RGB colour space.
   d. In one example, the derivation methods of IBC-LIC parameters for a first component may be same as a second component.
      i. Alternatively, the derivation methods of IBC-LIC parameters for a first component may be different from a second component.
   e. In one example, how to derive the IBC-LIC parameters may depend on colour component and/or colour format.
      i. In one example, the number of samples used to derive IBC-LIC parameters for chroma components may depend on colour format.
         1) In one example, the number of samples used chroma components may be same as luma component for 4:4:4 colour format.
         a) Alternatively, the number of samples used chroma components may be different from luma component for 4:4:4 colour format.
         2) In one example, the number of samples used chroma components may be different from luma component for 4:2:0/4:2:2 colour format.
         3) In one example, the minimum samples used to derive IBC-LIC parameters for chroma components may be same as luma component regardless of colour format.
   f. In one example, at least one parameter may be not derived for a second component (e.g., chroma component such as Cb and/or Cr) but inherited from a first component (e.g., Y).
   g. In one example, the IBC-LIC parameters may be derived individually for different components.
      i. Alternatively, at least one parameter may be shared by different components.
      ii. In one example, the different components may refer to luma and chroma components.
      iii. In one example, the different components may refer to chroma components (e.g., Cb and Cr).
   h. In one example, when a luma BV is used for chroma components, it may be modified depending on the colour format.
      i. In one example, BV_{C}=BV_{L}(x>>(SubWidthC−1), y>>(SubHeightC−1)).
      ii. In one example, BV_{C}=BV_{L}((x+1)>>(SubWidthC−1), (y+1)>>(SubHeightC−1)).
      iii. In one example, BV_{C}=BV_{L}((x−1)>>(SubWidthC−1), (y−1)>>(SubHeightC−1)).
      iv. In one example, BV_{C}=BV_{L}((x+1)>>(SubWidthC−1), (y−1)>>(SubHeightC−1)).
      v. In one example, BV_{C}=BV_{L}((x−1)>>(SubWidthC−1), (y+1)>>(SubHeightC−1)).
         1) In one example, BV_{C} may be used to derive the prediction of the chroma video unit.
         2) In one example, BV_{C} may be used to derive the reference template used to derive IBC-LIC parameters for chroma video unit.
         3) In one example, when BV_{C} is fractional BV, it may be rounded to the integer BV.
         a) In one example, clipping operation may be used when rounding the fractional BV.
         b) Alternatively, the fractional BV is still used to derive the reference template.
         i. In one example, the same interpolation method is used to derive the reference template as the interpolation method to derive the prediction of the chroma video unit.
         ii. Alternatively, a different interpolation method is used to derive the reference template as the interpolation method to derive the prediction of the video unit, such as different interpolation taps.
         1. In one example, 2-tap interpolation filter may be used.
            On signalling of IBC-LIC
13. Indication of the IBC-LIC mode may be conditionally signalled wherein the condition may include:
   a. whether a specific coding method is allowed, such as IBC (IBC AMVP or IBC merge), or RR-IBC, or CIBCIP (IBC-CIIP), or IBC-TM, or IBC-GPM
   b. block dimensions and/or block size
      i. In one example, the indication of the IBC-LIC mode may be not signalled when the block size (W×H) is less than or equal to a threshold (T3), wherein W and H denotes block width and block height, respectively.
         1) In one example, T3=256, or 512, or 1024, or 2048, or 4096.
         2) In one example, T3 may depend on whether IBC AMVP mode or IBC merge mode is used.
         3) In one example, T3 may depend on slice/picture type.
      ii. In one example, the indication of the IBC-LIC mode may be not signalled when the block size (W×H) is smaller than or equal to a threshold (T4), wherein W and H denotes block width and block height, respectively.
         1) In one example, T4=16, or 32, or 64, or 128, or 256.
         2) In one example, T4 may depend on whether IBC AMVP mode or IBC merge mode is used.
         3) In one example, T4 may depend on slice/picture type.
      iii. In one example, the block size may refer to luma block size.
   c. block depth
   d. slice/picture type and/or partition tree type (single, or dual tree, or local dual tree)
   e. temporal layer identification
   f. block location
   g. colour component
   h. In one example, the indication of the IBC-LIC mode may be not signalled but derived.
   i. In one example, if the indication of the IBC-LIC mode is not signalled, it may be inferred to be a default value.
      i. In one example, if the indication of the IBC-LIC mode is not signalled, it may be inferred to be false.
      ii. In one example, if the indication of the IBC-LIC mode is not signalled, it may be inferred to be true.
14. Whether current block is coded with IBC-LIC mode may be signalled using one or more syntax elements.
   a. In one example, the syntax element may be binarized with fixed length coding, or truncated unary coding, or unary coding, or EG coding, or coded a flag.
   b. In one example, the syntax element may be bypass coded or context coded.
      i. The context may depend on coded information, such as block dimensions, and/or block size, and/or slice/picture types, and/or the information of neighbouring blocks (adjacent or non-adjacent), and/or the information of other coding tools used for current block, and/or the information of temporal layer.
         1) In one example, the context may depend on whether the neighbouring blocks are coded with IBC-LIC.
   c. In one example, the indication of IBC-LIC mode may be signalled when current video unit is IBC coded.
   d. In one example, the indication of IBC-LIC mode may be not signalled when current video unit is IBC merge mode.
   e. In one example, the syntax element may be signalled before or after the indication of a specific coding tool.
      i. In one example, the specific coding tool may refer to RR-IBC mode, or IBC-TM mode, or IBC-MBVD mode, or CIBCIP (IBC-CIIP), or IBC-GPM.
      ii. In one example, whether to signal and/or how to the syntax element may be dependent on whether IBC mode, RR-IBC mode, or IBC-TM mode, or IBC-MBVD mode, or CIBCIP (IBC-CIIP), or IBC-GPM is enabled for the video unit.
      iii. In one example, the syntax element may be signalled after the indication of RR-IBC mode.
         1) In one example, when RR-IBC mode is applied, the syntax element indicating IBC-LIC is not signalled and set to a default value which indicates IBC-LIC is not applied.
      iv. In one example, the syntax element may be signalled when the video unit is IBC-AMVP mode.
   f. In one example, the one or more syntax elements may be signalled at sequence header/picture header/SPS/VPS/DPS/DCI/PPS/APS/slice header/tile group header.
   g. In one example, the syntax element may be coded in a predictive way.
   h. For example, the syntax element of the current block may be predicted by that of a neighboring block.
   i. In one example, whether a block is allowed to be coded with IBC-LIC mode may depend on one or more syntax elements.
      i. In one example, the one or more syntax elements may be signalled as general constraints information.
         1) In one example, when a syntax element (e.g., gci_no_ibc_lic_constraint_flag) indicating general constraint on IBC-LIC is equal to X1 (e.g., X1=0 or X1=1), IBC-LIC shall be not allowed.
         2) In one example, when either a syntax element (e.g., gci_no_ibc_constraint_flag) indicating general constraint on IBC is equal to X2 (e.g., X2=0 or X2=1), IBC-LIC shall be not allowed.
      ii. In one example, the one or more syntax elements may be signalled at sequence header/picture header/SPS/VPS/DPS/DCI/PPS/APS/slice header/tile group header.
15. Whether to and/or how to apply the disclosed methods above may depend on the video characteristics.
   a. In one example, the video characteristics may refer to screen content, camera-captured/natural content, mixed content.
      i. In one example, one or more syntax elements may be used to indicate whether the video unit belongs to which content.
      ii. In one example, which content the video unit belongs to may be determined adaptively, such as using the neighbouring reconstructed/original samples and/or prediction/original samples of the video unit, hash value.
      iii. In one example, which content the video unit belongs to may be determined adaptively, such as whether one or more neighbouring (adjacent or non-adjacent) video units are coded with a specific mode (e.g., IBC, Palette, IntraTMP).
16. The disclosed methods above may apply to other coding tools.
   a. In one example, the coding tool may refer to inter prediction, such as LIC.
   b. In one example, the coding tool may refer to intra prediction, such as IntraTMP.
   c. In one example, the coding tool may refer to in-loop filter.

### General Aspects

17. In above examples, the video unit may refer to the colour component/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/a block/sub-block of a block/sub-region within a block/any other region that contains more than one sample or pixel.
18. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
19. Whether to and/or how to apply the disclosed methods above may be signalled at PB/TB/CB/PU/TU/CU/VPDU/CTU/CTU row/slice/tile/sub-picture/other kinds of region contains more than one sample or pixel.
20. Whether to and/or how to apply the disclosed methods above may be dependent on coded information, such as block size, colour format, single/dual tree partitioning, colour component, slice/picture type.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick. The term “reference line” may refer to a row and/or a column reconstructed samples adjacent to or non-adjacent to the current block, which is used to derive the intra prediction of current video unit via an interpolation filter along a certain direction, and the certain direction is determined by an intra prediction mode (e.g., conventional intra prediction with intra prediction modes), or derive the intra prediction of current video unit via weighting the reference samples of the reference line with a matrix or vector (e.g., MIP).

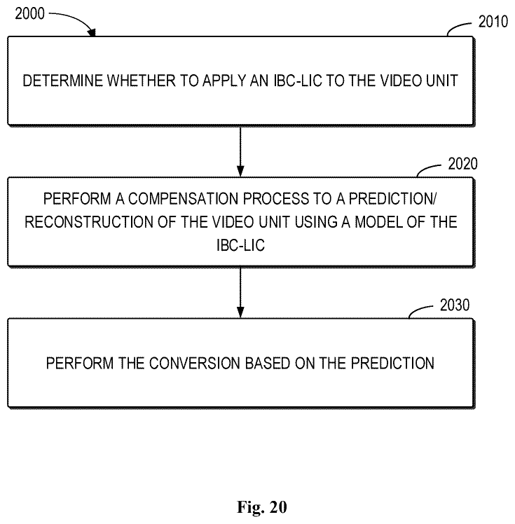

FIG. 20 illustrates a flowchart of a method 2000 for video processing in accordance with embodiments of the present disclosure. The method 2000 is implemented during a conversion between a video unit of a video and a bitstream of the video.

At block 2010, for a conversion between a video unit of a video and a bitstream of the video, it determines that whether an intra block copy (IBC) and local illumination compensation (LIC) (IBC-LIC) is applied to the video unit.

At block 2020, if the IBC-LIC is applied to the video unit, a compensation process is performed to a prediction/reconstruction of the video unit using a model of the IBC-LIC.

At block 2030, the conversion is performed based on the compensated prediction/reconstruction of the video unit. In some embodiments, the conversion may include encoding the video unit into the bitstream. Alternatively, or in addition, the conversion may include decoding the video unit from the bitstream. In this way, it can improve coding efficiency and coding performance.

In some embodiments, one or more offsets are used to modify one or more parameters of the model. In an example, the one or more offsets are indicated. In another example, the one or more offsets are derived. In a further example, the one or more offsets are predefined.

In some embodiments, whether to and/or a way to use the one or more offsets to modify the one or more parameters is indicated. Alternatively, whether to and/or a way to use the one or more offsets to modify the one or more parameters is predefined. In some other embodiments, whether to and/or a way to use the one or more offsets to modify the one or more parameters is determined based on coding information.

In some embodiments, the model may be c₀×x₀+c₁×x₁+c₂×x₂+ . . . +c_{N}×x_{N}+B, where cᵢ are the parameters and xᵢ denote the coding information, i is an integer number and in a range from 0 to N, N is a predefined number, B represents a bias parameter which is derived together with cᵢ. For example, the coding information comprises at least one of: reconstruction samples, reference samples, prediction samples, values calculated using the reconstruction samples, values calculated using the reference samples, values calculated using the prediction samples, position information of the reconstruction samples, position information of the reference samples, or position information of the prediction samples.

In some embodiments, a current template including neighboring reconstructed samples of the video unit and a reference template are used to derive parameters of the model. In this case, the reference template may be derived using a block vector (BV) that is used to obtain the prediction of the video unit.

In some embodiments, if the BV is a fractional BV, the fractional BV is rounded to an integer BV. For example, a clipping operation is used during rounding the fractional BV. Alternatively, if the BV is a fractional BV, the fractional BV is used to derive the reference template.

In some embodiments, an interpolation method used to derive the reference template is same as an interpolation method used to derive the prediction of the video unit. Alternatively, an interpolation method used to derive the reference template is different as an interpolation method used to derive the prediction of the video unit. For example, the interpolation method used to derive the reference template and the interpolation method used to derive the prediction of the video unit have different interpolation taps. In some embodiments, 2-tap interpolation filter is used to derive the reference template.

In some embodiments, a way solving a model used for another coding tool is used to derive parameters of the model. In one example, the method solving a linear/non-linear equation (e.g., MSE minimization) used for other coding tools may be used to derive the parameters.

In some embodiments, the way is Cholesky decomposition used in adaptive loop filtering (ALF) and one or more variants of Cholesky decomposition. In some other embodiments, the way is LDL decomposition used in convolutional cross-component model (CCCM) and one or more variants of LDL decomposition. Alternatively, the way is Gaussian elimination used in CCCM and one or more variants of Gaussian elimination.

In some embodiments, a mean square error (MSE) minimization is used as a metric to solve the model. For example, one or more other metrics used to solve the model. As an example, the one or more other metrics comprises at least one of: sum of squared error (SSE) or a mean of SSE. In some embodiments, a subjective metric is used to solve the model. For example, the subjective metric comprises a structure similarity index measure (SSIM).

In some embodiments, more than one way is used to derive parameters for IBC-LIC. In some embodiments, which way is used to derive the parameters is indicated. Alternatively, which way is used to derive the parameters is predefined. In some other embodiments, which way is used to derive the parameters is determined based coding information.

In some embodiments, more than one way is used to derive more than one set of parameters, and predictions of the current video unit modified using the more than one set of parameters are fused. In some embodiments, weights used for the fusion are predefined. Alternatively, the weights used for the fusion are indicated. In some other embodiments, the weights used for the fusion are determined based on coding information.

In some embodiments, the IBC-LIC is used in a process of reordering a BV candidate list. For example, two-pass reordering is used to reorder the BV candidate list. In some embodiments, the IBC-LIC is applied in at least one of: a first pass reordering, or a second pass reordering. In some embodiments, the IBC-LIC is applied to partial BV candidates in the BV candidate list.

In some embodiments, whether to and/or an approach to apply the IBC-LIC depends on coding information of the video unit. The coding information of the video unit may include at least one of: a block dimension, a block size, a depth of the video unit, a slice type, a picture type, a partition tree type, a block location, a quantization parameter, or a colour component.

In some embodiments, a block is allowed to be coded with the IBC-LIC, if a block size is larger than or equal to a first threshold, where the block size is equal to W×H, and W and H denotes block width and block height of the block, respectively. In some embodiments, the first threshold is equal to one of: 4, 8, 16, 32, 64, 128, or 256.

In some other embodiments, a block is allowed to be coded with the IBC-LIC, if a block size is less than or equal to a second threshold, where the block size is equal to W×H, and W and H denotes block width and block height of the block, respectively. In some embodiments, the second threshold is equal to one of: 4, 8, 16, 32, 64, 128, or 256. In some embodiments, the second threshold depends on whether IBC advanced motion vector prediction (AMVP) mode or IBC merge mode is used. In some other embodiments, the second threshold depends on slice type or picture type.

In some embodiments, a block is allowed to be coded with the IBC-LIC, if a block size is larger than or equal to a third threshold, where the block size is equal to W×H, and W and H denotes block width and block height of the block, respectively. In some embodiments, the third threshold is equal to one of: 4, 8, 16, 32, 64, 128, or 256. In some other embodiments, the third threshold depends on whether IBC AMVP mode or IBC merge mode is used. In some further embodiments, the third threshold depends on slice type or picture type. In some embodiments, the block size refers to chroma block size.

In some embodiments, more than one LIC equation is used to compensate the prediction or reconstruction of the video unit, and parameters of the more than one LIC equations are derived using different templates. In some embodiments, at least one of the following templates is used to derive the parameters: left template, above template, left-above template, left-below template, or above-right template. In some embodiments, the templates are adjacent. Alternatively, the templates are non-adjacent.

In some embodiments, more than one way is used to derive parameters for IBC-LIC. In some embodiments, which way is used to derive the parameters is indicted. Alternatively, which way is used to derive the parameters is predefined. In some other embodiments, which way is used to derive the parameters is determined based on coding information.

In some embodiments, more than one way and/or more than one template is used to derive more than one set of parameters of the model, and predictions of the video unit modified by the more than one set of parameters are fused. In some embodiments, weights used for the fusion are pre-defined. Alternatively, the weights used for the fusion are indicated. In some other embodiments, the weights used for the fusion are determined based on coding information.

In some embodiments, one or more of: at least one parameter in the model or at least one IBC-LIC model used for video units coded before a current video unit are used for the current video unit. Alternatively, or in addition, one or more of: at least one parameter in the model or at least one IBC-LIC model used for video units decoded before a current video unit are used for the current video unit.

In some embodiments, the video units coded or decoded before the current video unit are in one of: a different slice, a different tile, a different picture, a different coding tree unit (CTU), or a different CTU row. In some other embodiments, the video units coded or decoded before the current video unit are in one of: a same slice as the current video unit, a same tile as the current video unit, a same picture as the current video unit, a same CTU as the current video unit, or a same CTU row as the current video unit.

In some embodiments, the video units coded or decoded before the current video unit are neighbouring spatial video units. In some embodiments, the neighbouring spatial video units are adjacent video units. Alternatively, or in addition, the neighbouring spatial video units are non-adjacent video units.

In some embodiments, reused parameters are stored in a list or a table. For example, the table is a history-based motion vector prediction IBC-LIC parameter table. In some embodiments, the list or table is updated during a coding process. Alternatively, or in addition, the list or table is updated during a decoding process.

In some embodiments, a maximum size of the list or table is predefined. Alternatively, the maximum size of the list or table is indicated. In some other embodiments, the maximum size of the list or table is derived.

In some embodiments, the list or table is re-initialized at a beginning of one of: a slice, a tile, a picture, or a CTU. In some embodiments, the list is re-initialized as a void list. Alternatively, the table is re-initialized as a void table. In some other embodiments, the list or table is re-initialized using one or more parameters. In some embodiments, the one or more parameters are predefined. Alternatively, the one or more parameters are derived. In some other embodiments, the one or more parameters are indicated.

In some embodiments, whether to and/or how to use the list or table depends on coding information. Alternatively, whether to and/or how to update the list or table depends on coding information. In some embodiments, the coding information comprises at least one of: block dimensions, block size, or block position. In some embodiments, if the current video unit is chroma video unit, reused parameters are from at least one of luma video unit or chroma video unit.

In some embodiments, the IBC-LIC is applied to sub-blocks within the video unit which is a current video unit. In some embodiments, whether to and/or how to apply the IBC-LIC to the sub-blocks is predefined. Alternatively, whether to and/or how to apply the IBC-LIC to the sub-blocks is indicated. For example, a syntax element is used to indicate whether the IBC-LIC is applied with sub-block level. In some other embodiments, whether to and/or how to apply the IBC-LIC to the sub-blocks is determined. In some embodiments, whether to and/or how to apply the IBC-LIC to the sub-blocks depends on block dimensions or block size.

In some embodiments, the IBC-LIC is applied to all sub-blocks. Alternatively, the IBC-LIC is not applied to all sub-blocks.

In some embodiments, the IBC-LIC is applied to partial sub-blocks, and the IBC-LIC is not applied to other sub-blocks. In some embodiments, the partial sub-blocks to which the IBC-LIC is applied are boundary sub-blocks.

In some embodiments, IBC-LIC parameters are different for at least one sub-block. In some other embodiments, IBC-LIC parameters are shared by at least one sub-block.

In some embodiments, the method 2000 may also include determining whether the video unit is allowed to be coded with an IBC with LIC mode based on coded information of the video unit. In some embodiments, the coed information comprises at least one of: a block dimension, a block size, a depth of a block, a block location, a slice type, a picture type, a temporal layer, a colour format, or a colour component.

In some embodiments, if the block size that is represented as W×H is less than or equal to a fourth threshold, the video unit is allowed to be coded with the IBC with LIC mode, where W represents a block width of the video unit and H represents a block height of the video unit. In some embodiments, the fourth threshold depends on whether IBC AMVP mode or IBC merge mode is used. Alternatively, the fourth threshold depends on slice type or picture.

In some embodiments, if the block size that is represented as W×H is larger than or equal to a fifth threshold, the video unit is allowed to be coded with the IBC with LIC mode, where W represents a block width of the video unit and H represents a block height of the video unit. In some embodiments, the fifth threshold is one of: 4, 8, 16, 32, 64, 128, 256, 512, 1024, or 2048. In some other embodiments, the fifth threshold depends on whether IBC AMVP mode or IBC merge mode is used. Alternatively, the fifth threshold depends on slice type or picture.

In some embodiments, if the block size that is represented as W×H is less than or equal to a sixth threshold, the video unit is allowed to be coded with the IBC with LIC mode, where W represents a block width of the video unit and H represents a block height of the video unit. In some embodiments, the sixth threshold is one of: 4, 8, 16, 32, 64, 128, or 256. In some other embodiments, the sixth threshold depends on whether IBC AMVP mode or IBC merge mode is used. Alternatively, the sixth threshold depends on slice type or picture.

In some embodiments, if the block size that is represented as W×H is larger than or equal to a seventh threshold, the video unit is allowed to be coded with the IBC with LIC mode, where W represents a block width of the video unit and H represents a block height of the video unit. In some embodiments, the seventh threshold is one of: 4, 8, 16, 32, 64, 128, or 256. In some other embodiments, the seventh threshold depends on whether IBC AMVP mode or IBC merge mode is used. Alternatively, the seventh threshold depends on slice type or picture.

In some embodiments, the block size is luma block size. In some other embodiments, the block size is chroma block size.

In some embodiments, a determination of whether to and/or how to apply the IBC-LIC to a first video unit in a first component depends on a second video unit in a second component. In some embodiments, the second video unit is a collocated luma video unit of the first video unit. In some embodiments, P_{L}(x, y)=P_{C}(x*SubWidthC, y*SubHeightC), and where P_{C} represents a position of the first video unit, P_{L} represents a position of the second video unit, SubWidthC represents a subblock width, SubHeightC represents a subblock height, x represents a coordinate in horizontal direction, y represents a coordinate in a vertical direction.

In one example, (P_{C}(x, y)) may refer to the center position of the chroma video unit. The width and height of the chroma video unit may be represented as W and H, and x is in the range of 0 and W−1, inclusive, and y is in the range of 0 and H−1, inclusive. In one example, (P_{C}(x, y))=(W/2−1, H/2+1). In one example, (P_{C}(x, y))=(W/2+1, H/2−1). In one example, (P_{C}(x, y))=(W/2−1, H/2+1). In one example, (P_{C}(x, y))=(W/2+1, H/2+1). In some embodiments, (P_{C}(x, y)) refers to one of: a left-top position of the chroma video unit, a right-top position of the chroma video unit, a left-bottom position of the chroma video unit, or a right-bottom position of the chroma video unit.

In some embodiments, the second video unit is a collocated luma video unit of the first video unit. In some embodiments, the second video unit is a spatial neighbouring luma video unit of the collocated luma video unit. For example, the spatial neighbouring luma video unit is an adjacent neighbouring luma video unit. Alternatively, the spatial neighbouring luma video unit may be a non-adjacent neighbouring luma video unit.

In some embodiments, the spatial neighbouring luma video unit comprises one of: a left neighbouring luma video unit, a left-below neighbouring luma video unit, a left-above neighbouring luma video unit, an above neighbouring luma video unit, or an above-right neighbouring luma video unit. In some other embodiments, the spatial neighbouring luma video unit of the collocated luma video unit is used, if the collocated luma video unit is not coded with IBC mode or intra template matching prediction (IntraTMP) mode. In some embodiments, the IBC-LIC is applied to the first video unit, if the second video unit is coded with IBC mode or IntraTMP mode.

In some embodiments, a derivation way of IBC-LIC parameters for a first component is same as a derivation way of IBC-LIC parameters for a second component. In some other embodiments, the derivation way of IBC-LIC parameters for the first component is different from the derivation way of IBC-LIC parameters for the second component.

In some embodiments, a way to derive IBC-LIC parameters depends on at least one of colour component or colour format. In some embodiments, the number of samples used to derive the IBC-LIC parameters for chroma components depends on colour format. For example, the number of samples used for chroma components is same as luma component for 4:4:4 colour format. Alternatively, the number of samples used for chroma components is different from luma component for 4:4:4 colour format. In some embodiments, the number of samples used for chroma components is different from luma component for 4:2:0/4:2:2 colour format. In some other embodiments, a minimum number of samples used to derive the IBC-LIC parameters for chroma components is same as luma component regardless of colour format.

In some embodiments, at least one parameter is not derived for a second component but inherited from a first component. In some embodiments, the first component is Y component, and the second component is a chroma component (such as Cb and/or Cr).

In some embodiments, IBC-LIC parameters are derived individually for different components. Alternatively, at least one IBC-LIC parameter is shared by different components. In some embodiments, the components comprise luma and chroma components. In some other embodiments, the components comprise chroma components (e.g., Cb and Cr).

In some embodiments, if a luma BV is used for chroma components, the luma BV is modified depending on the colour format. In one example, BV_{C}=BV_{L}((x+1)>>(SubWidthC−1), (y+1)>>(SubHeightC−1)). In one example, BV_{C}=BV_{L}((x−1)>>(SubWidthC−1), (y−1)>>(SubHeightC−1)). In one example, BV_{C}=BV_{L}((x+1)>>(SubWidthC−1), (y−1)>>(SubHeightC−1)). In one example, BV_{C}=BV_{L}((x−1)>>(SubWidthC−1), (y+1)>>(SubHeightC−1)). In above cases, BV_{L} represents the luma BV, BV_{C} represents a chroma BV, SubWidthC represents a subblock width, SubHeightC represents a subblock height, x represents a coordinate in horizontal direction, y represents a coordinate in a vertical direction.

In some embodiments, BV_{C} is used to derive a prediction of a chroma video unit. In some other embodiments, BV_{C} is used to derive a reference template used to derive IBC-LIC parameters for a chroma video unit.

In some embodiments, if BV_{C} is a fractional BV, BV_{C} is rounded to an integer BV. For example, a clipping operation is used during rounding the fractional BV. Alternatively, the fractional BV is used to derive the reference template.

In some embodiments, an interpolation method used to derive the reference template is same as an interpolation method used to derive the prediction of the chroma video unit. In some other embodiments, an interpolation method used to derive the reference template is different as an interpolation method used to derive the prediction of the chroma video unit.

In some embodiments, the interpolation method used to derive the reference template and the interpolation method used to derive the prediction of the video unit have different interpolation taps. For example, 2-tap interpolation filter is used to derive the reference template.

In some embodiments, whether to and/or how to perform the compensation process to the prediction/reconstruction of the video unit using a model of the IBC-LIC depends on video characteristics. In some embodiments, the video characteristics comprises at least one of: screen content, camera-captured content, natural content, or mixed content.

In some embodiments, one or more syntax elements are used to indicate whether the video unit belongs to which content. In some embodiments, which content the video unit belongs to is determined adaptively. For example, which content the video unit belongs to is determined using at least one of: neighboring reconstructed samples of the video unit, neighboring original samples, prediction samples of the video unit, original samples of the video unit, hash value, or one or more neighboring video units are coded with a mode.

In some embodiments, the video unit is applied with other coding tools. In some embodiments, the other coding tool comprises an inter prediction, or wherein the other coding tool comprises an intra prediction, or wherein the other coding tool comprises an in-loop filter. In some embodiments, the inter prediction is a local illumination compensation (LIC). Alternatively, the intra prediction comprises IntraTMP.

In some embodiments, the video unit comprises at least one of: a color component, a prediction block (PB), a transform block (TB), a coding block (CB), a prediction unit (PU), a transform unit (TU), a coding tree block (CTB), a coding unit (CU), a coding tree unit (CTU), a CTU row, groups of CTU, a slice, a tile, a sub-picture, a block, a sub-region within a block, or a region containing more than one sample or pixel.

In some embodiments, an indication of whether to and/or how to perform the compensation process to the prediction/reconstruction of the video unit using the model of the IBC-LIC is indicated at one of the followings: sequence level, group of pictures level, picture level, slice level, or tile group level. In some embodiments, an indication of whether to and/or how to perform the compensation process to the prediction/reconstruction of the video unit using the model of the IBC-LIC is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header. In some embodiments, an indication of whether to and/or how to perform the compensation process to the prediction/reconstruction of the video unit using the model of the IBC-LIC is indicated at one of the following: a PB, a TB, a CB, a PU, a TU, a CU, a VPDU, a CTU, a CTU row, a slice, a tile, a sub-picture, or a region contains more than one sample or pixel.

In some embodiments, whether to and/or how to perform the compensation process to the prediction/reconstruction of the video unit using the model of the IBC-LIC is coded information of the video unit. The coded information may include at least one of a block size, a colour format, a single tree partitioning, a dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: determining whether an intra block copy (IBC) and local illumination compensation (LIC) (IBC-LIC) is applied to a video unit of the video; in accordance with a determination that the IBC-LIC is applied to the video unit, performing a compensation process to a prediction/reconstruction of the video unit using a model of the IBC-LIC; and generating the bitstream based on the compensated prediction/reconstruction of the video unit.

According to still further embodiments of the present disclosure, a method for storing bitstream of a video is provided. The method comprises: determining whether an intra block copy (IBC) and local illumination compensation (LIC) (IBC-LIC) is applied to a video unit of the video; in accordance with a determination that the IBC-LIC is applied to the video unit, performing a compensation process to a prediction/reconstruction of the video unit using a model of the IBC-LIC; generating the bitstream based on the compensated prediction/reconstruction of the video unit; and storing the bitstream in a non-transitory computer-readable recording medium.

Implementations of the present disclosure can be described in view of the following clauses, the features of which can be combined in any reasonable manner.

Clause 1. A method of video processing, comprising: determining, for a conversion between a video unit of a video and a bitstream of the video, whether an intra block copy (IBC) and local illumination compensation (LIC) (IBC-LIC) is applied to the video unit based on a model used for the IBC-LIC; in accordance with a determination that the IBC-LIC is applied to the video unit, performing a compensation process to a prediction/reconstruction of the video unit using a model of the IBC-LIC; and performing the conversion based on the compensated prediction/reconstruction of the video unit.

Clause 2. The method of clause 1, wherein one or more offsets are used to modify one or more parameters of the model.

Clause 3. The method of clause of clause 2, wherein the one or more offsets are indicated, or wherein the one or more offsets are derived, or wherein the one or more offsets are predefined.

Clause 4. The method of clause 2, wherein whether to and/or a way to use the one or more offsets to modify the one or more parameters is indicated, or wherein whether to and/or a way to use the one or more offsets to modify the one or more parameters is predefined, or wherein whether to and/or a way to use the one or more offsets to modify the one or more parameters is determined based on coding information.

Clause 5. The method of clause 1, wherein the model is presented as: c₀×x₀+c₁×x₁+c₂×x₂+ . . . +c_{N}×x_{N}+B, and wherein ci represents a parameter and xi represents coding information, i is an integer number and in a range from 0 to N, N is a predefined number, B represents a bias parameter which is derived together with cᵢ.

Clause 6. The method of clause 5, wherein the coding information comprises at least one of: reconstruction samples, reference samples, prediction samples, values calculated using the reconstruction samples, values calculated using the reference samples, values calculated using the prediction samples, position information of the reconstruction samples, position information of the reference samples, or position information of the prediction samples.

Clause 7. The method of clause 1, wherein a current template comprising neighboring reconstructed samples of the video unit and a reference template are used to derive parameters of the model, and the reference template is derived using a block vector (BV) that is used to obtain the prediction of the video unit.

Clause 8. The method of clause 7, wherein if the BV is a fractional BV, the fractional BV is rounded to an integer BV.

Clause 9. The method of clause 8, wherein a clipping operation is used during rounding the fractional BV.

Clause 10. The method of clause 7, wherein if the BV is a fractional BV, the fractional BV is used to derive the reference template.

Clause 11. The method of clause 10, wherein an interpolation method used to derive the reference template is same as an interpolation method used to derive the prediction of the video unit.

Clause 12. The method of clause 10, wherein an interpolation method used to derive the reference template is different as an interpolation method used to derive the prediction of the video unit.

Clause 13. The method of clause 12, wherein the interpolation method used to derive the reference template and the interpolation method used to derive the prediction of the video unit have different interpolation taps.

Clause 14. The method of clause 12, wherein 2-tap interpolation filter is used to derive the reference template.

Clause 15. The method of clause 1, wherein a way solving a model used for another coding tool is used to derive parameters of the model.

Clause 16. The method of clause 15, wherein the way is Cholesky decomposition used in adaptive loop filtering (ALF) and a variant of Cholesky decomposition.

Clause 17. The method of clause 15, wherein the way is LDL decomposition used in convolutional cross-component model (CCCM) and one or more variants of LDL decomposition.

Clause 18. The method of clause 15, wherein the way is Gaussian elimination used in CCCM and one or more variants of Gaussian elimination.

Clause 19. The method of clause 1, wherein a mean square error (MSE) minimization is used as a metric to solve the model.

Clause 20. The method of clause 19, wherein one or more other metrics used to solve the model.

Clause 21. The method of clause 20, wherein the one or more other metrics comprises at least one of: sum of squared error (SSE) or a mean of SSE.

Clause 22. The method of clause 19, wherein a subjective metric is used to solve the model.

Clause 23. The method of clause 22, wherein the subjective metric comprises a structure similarity index measure (SSIM).

Clause 24. The method of clause 1, wherein more than one way is used to derive parameters for IBC-LIC.

Clause 25. The method of clause 24, wherein which way is used to derive the parameters is indicated, or wherein which way is used to derive the parameters is predefined, or wherein which way is used to derive the parameters is determined based coding information.

Clause 26. The method of clause 1, wherein more than one way is used to derive more than one set of parameters, and predictions of the current video unit modified using the more than one set of parameters are fused.

Clause 27. The method of clause 26, wherein weights used for the fusion are predefined, or wherein the weights used for the fusion are indicated, or wherein the weights used for the fusion are determined based on coding information.

Clause 28. The method of clause 1, wherein the IBC-LIC is used in a process of reordering a BV candidate list.

Clause 29. The method of clause 28, wherein two-pass reordering is used to reorder the BV candidate list.

Clause 30. The method of clause 29, wherein the IBC-LIC is applied in at least one of: a first pass reordering, or a second pass reordering.

Clause 31. The method of clause 28, wherein the IBC-LIC is applied to partial BV candidates in the BV candidate list.

Clause 32. The method of any of clauses 1-31, wherein whether to and/or an approach to apply the IBC-LIC depends on coding information of the video unit, and wherein the coding information of the video unit comprises at least one of: a block dimension, a block size, a depth of the video unit, a slice type, a picture type, a partition tree type, a block location, a quantization parameter, or a colour component.

Clause 33. The method of clause 32, wherein a block is allowed to be coded with the IBC-LIC, if a block size is larger than or equal to a first threshold, wherein the block size is equal to W×H, and W and H denotes block width and block height of the block, respectively.

Clause 34. The method of clause 33, wherein the first threshold is equal to one of: 4, 8, 16, 32, 64, 128, or 256.

Clause 35. The method of clause 32, wherein a block is allowed to be coded with the IBC-LIC, if a block size is less than or equal to a second threshold, wherein the block size is equal to W×H, and W and H denotes block width and block height of the block, respectively.

Clause 36. The method of clause 35, wherein the second threshold is equal to one of: 4, 8, 16, 32, 64, 128, or 256.

Clause 37. The method of clause 35, wherein the second threshold depends on whether IBC advanced motion vector prediction (AMVP) mode or IBC merge mode is used.

Clause 38. The method of clause 35, wherein the second threshold depends on slice type or picture type.

Clause 39. The method of clause 32, wherein a block is allowed to be coded with the IBC-LIC, if a block size is larger than or equal to a third threshold, wherein the block size is equal to W×H, and W and H denotes block width and block height of the block, respectively.

Clause 40. The method of clause 39, wherein the third threshold is equal to one of: 4, 8, 16, 32, 64, 128, or 256.

Clause 41. The method of clause 39, wherein the third threshold depends on whether IBC AMVP mode or IBC merge mode is used.

Clause 42. The method of clause 39, wherein the third threshold depends on slice type or picture type.

Clause 43. The method of any of clauses 32-42, wherein the block size refers to chroma block size.

Clause 44. The method of clause 1, wherein more than one LIC equation is used to compensate the prediction or reconstruction of the video unit, and parameters of the more than one LIC equations are derived using different templates.

Clause 45. The method of clause 44, wherein at least one of the following templates is used to derive the parameters: left template, above template, left-above template, left-below template, or above-right template.

Clause 46. The method of clause 45, wherein the templates are adjacent, and/or wherein the templates are non-adjacent.

Clause 47. The method of clause 1, wherein more than one way is used to derive parameters for IBC-LIC.

Clause 48. The method of clause 47, wherein which way is used to derive the parameters is indicted, or wherein which way is used to derive the parameters is predefined, or wherein which way is used to derive the parameters is determined based on coding information.

Clause 49. The method of clause 1, wherein more than one way and/or more than one template is used to derive more than one set of parameters of the model, and predictions of the video unit modified by the more than one set of parameters are fused.

Clause 50. The method of clause 49, wherein weights used for the fusion are pre-defined, or wherein the weights used for the fusion are indicated, or wherein the weights used for the fusion are determined based on coding information.

Clause 51. The method of clause 1, wherein one or more of: at least one parameter in the model or at least one IBC-LIC model used for video units coded before a current video unit are used for the current video unit, and/or wherein one or more of: at least one parameter in the model or at least one IBC-LIC model used for video units decoded before a current video unit are used for the current video unit.

Clause 52. The method of clause 51, wherein the video units coded or decoded before the current video unit are in one of: a different slice, a different tile, a different picture, a different coding tree unit (CTU), or a different CTU row.

Clause 53. The method of clause 51, wherein the video units coded or decoded before the current video unit are in one of: a same slice as the current video unit, a same tile as the current video unit, a same picture as the current video unit, a same CTU as the current video unit, or a same CTU row as the current video unit.

Clause 54. The method of clause 51, wherein the video units coded or decoded before the current video unit are neighbouring spatial video units.

Clause 55. The method of clause 54, wherein the neighbouring spatial video units are adjacent video units, and/or wherein the neighbouring spatial video units are non-adjacent video units.

Clause 56. The method of clause 51, wherein reused parameters are stored in a list or a table.

Clause 57. The method of clause 56, wherein the table is a history-based motion vector prediction IBC-LIC parameter table.

Clause 58. The method of clause 56, wherein the list or table is updated during a coding process, and/or wherein the list or table is updated during a decoding process.

Clause 59. The method of clause 56, wherein a maximum size of the list or table is predefined, or wherein the maximum size of the list or table is indicated, or wherein the maximum size of the list or table is derived.

Clause 60. The method of clause 56, wherein the list or table is re-initialized at a beginning of one of: a slice, a tile, a picture, or a CTU.

Clause 61. The method of clause 60, wherein the list is re-initialized as a void list, or wherein the table is re-initialized as a void table.

Clause 62. The method of clause 60, wherein the list or table is re-initialized using one or more parameters.

Clause 63. The method of clause 62, wherein the one or more parameters are predefined, or wherein the one or more parameters are derived, or wherein the one or more parameters are indicated.

Clause 64. The method of clause 56, wherein whether to and/or how to use the list or table depends on coding information, or wherein whether to and/or how to update the list or table depends on coding information.

Clause 65. The method of clause 64, wherein the coding information comprises at least one of: block dimensions, block size, or block position.

Clause 66. The method of clause 51, wherein if the current video unit is chroma video unit, reused parameters are from at least one of luma video unit or chroma video unit.

Clause 67. The method of clause 1, wherein the IBC-LIC is applied to sub-blocks within the video unit which is a current video unit.

Clause 68. The method of clause 67, wherein whether to and/or how to apply the IBC-LIC to the sub-blocks is predefined, or wherein whether to and/or how to apply the IBC-LIC to the sub-blocks is indicated, or wherein whether to and/or how to apply the IBC-LIC to the sub-blocks is determined.

Clause 69. The method of clause 68, wherein a syntax element is used to indicate whether the IBC-LIC is applied with sub-block level.

Clause 70. The method of clause 68, wherein whether to and/or how to apply the IBC-LIC to the sub-blocks depends on block dimensions or block size.

Clause 71. The method of clause 68, wherein the IBC-LIC is applied to all sub-blocks, or wherein the IBC-LIC is not applied to all sub-blocks.

Clause 72. The method of clause 68, wherein the IBC-LIC is applied to partial sub-blocks, and the IBC-LIC is not applied to other sub-blocks.

Clause 73. The method of clause 72, wherein the partial sub-blocks to which the IBC-LIC is applied are boundary sub-blocks.

Clause 74. The method of clause 67, wherein IBC-LIC parameters are different for at least one sub-block.

Clause 75. The method of clause 67, wherein IBC-LIC parameters are shared by at least one sub-block.

Clause 76. The method of clause 1, further comprising determining whether the video unit is allowed to be coded with an IBC with LIC mode based on coded information of the video unit.

Clause 77. The method of clause 76, wherein the coded information comprises at least one of: a block dimension, a block size, a depth of a block, a block location, a slice type, a picture type, a temporal layer, a colour format, or a colour component.

Clause 78. The method of clause 77, wherein if the block size that is represented as WH is less than or equal to a fourth threshold, the video unit is allowed to be coded with the IBC with LIC mode, wherein W represents a block width of the video unit and H represents a block height of the video unit.

Clause 79. The method of clause 78, wherein the fourth threshold depends on whether IBC AMVP mode or IBC merge mode is used, or wherein the fourth threshold depends on slice type or picture.

Clause 80. The method of clause 77, wherein if the block size that is represented as WH is larger than or equal to a fifth threshold, the video unit is allowed to be coded with the IBC with LIC mode, wherein W represents a block width of the video unit and H represents a block height of the video unit.

Clause 81. The method of clause 80, wherein the fifth threshold is one of: 4, 8, 16, 32, 64, 128, 256, 512, 1024, or 2048.

Clause 82. The method of clause 80, wherein the fifth threshold depends on whether IBC AMVP mode or IBC merge mode is used, or wherein the fifth threshold depends on slice type or picture.

Clause 83. The method of clause 77, wherein if the block size that is represented as WH is less than or equal to a sixth threshold, the video unit is allowed to be coded with the IBC with LIC mode, wherein W represents a block width of the video unit and H represents a block height of the video unit.

Clause 84. The method of clause 83, wherein the sixth threshold is one of: 4, 8, 16, 32, 64, 128, or 256.

Clause 85. The method of clause 83, wherein the sixth threshold depends on whether IBC AMVP mode or IBC merge mode is used, or wherein the sixth threshold depends on slice type or picture.

Clause 86. The method of clause 77, wherein if the block size that is represented as WH is larger than or equal to a seventh threshold, the video unit is allowed to be coded with the IBC with LIC mode, wherein W represents a block width of the video unit and H represents a block height of the video unit.

Clause 87. The method of clause 86, wherein the seventh threshold is one of: 4, 8, 16, 32, 64, 128, or 256.

Clause 88. The method of clause 86, wherein the seventh threshold depends on whether IBC AMVP mode or IBC merge mode is used, or wherein the seventh threshold depends on slice type or picture.

Clause 89. The method of clause 77, wherein the block size is luma block size.

Clause 90. The method of clause 77, wherein the block size is chroma block size.

Clause 91. The method of clause 1, wherein a determination of whether to and/or how to apply the IBC-LIC to a first video unit in a first component depends on a second video unit in a second component.

Clause 92. The method of clause 91, wherein the second video unit is a collocated luma video unit of the first video unit.

Clause 93. The method of clause 92, wherein P_{L}(x, y)=P_{C}(x*SubWidthC, y*SubHeightC), and wherein P_{C} represents a position of the first video unit, P_{L} represents a position of the second video unit, SubWidthC represents a subblock width, SubHeightC represents a subblock height, x represents a coordinate in horizontal direction, y represents a coordinate in a vertical direction.

Clause 94. The method of clause 92, wherein (P_{C}(x, y))=(W/2−1, H/2+1), or wherein (P_{C}(x, y))=(W/2+1, H/2−1), or wherein (P_{C}(x, y))=(W/2−1, H/2+1), or wherein (P_{C}(x, y))=(W/2+1, H/2+1), wherein P_{C} represents a center position of a chroma video unit, W represents a width of the chroma video unit, H represents a height of the chroma video unit, x is in a range from 0 to W−1, inclusive, and y is in a range of 0 to H−1 inclusive.

Clause 95. The method of clause 92, wherein (P_{C}(x, y)) refers to one of: a left-top position of the chroma video unit, a right-top position of the chroma video unit, a left-bottom position of the chroma video unit, or a right-bottom position of the chroma video unit.

Clause 96. The method of clause 91, wherein the second video unit is a collocated luma video unit of the first video unit.

Clause 97. The method of clause 91, wherein the second video unit is a spatial neighbouring luma video unit of the collocated luma video unit.

Clause 98. The method of clause 96, wherein the spatial neighbouring luma video unit is an adjacent neighbouring luma video unit, or wherein the spatial neighbouring luma video unit is a non-adjacent neighbouring luma video unit.

Clause 99. The method of clause 96, wherein the spatial neighbouring luma video unit comprises one of: a left neighbouring luma video unit, a left-below neighbouring luma video unit, a left-above neighbouring luma video unit, an above neighbouring luma video unit, or an above-right neighbouring luma video unit.

Clause 100. The method of clause 96, wherein the spatial neighbouring luma video unit of the collocated luma video unit is used, if the collocated luma video unit is not coded with IBC mode or intra template matching prediction (IntraTMP) mode.

Clause 101. The method of clause 91, wherein the IBC-LIC is applied to the first video unit, if the second video unit is coded with IBC mode or IntraTMP mode.

Clause 102. The method of clause 1, wherein a derivation way of IBC-LIC parameters for a first component is same as a derivation way of IBC-LIC parameters for a second component.

Clause 103. The method of clause 1, wherein the derivation way of IBC-LIC parameters for the first component is different from the derivation way of IBC-LIC parameters for the second component.

Clause 104. The method of clause 1, wherein a way to derive IBC-LIC parameters depends on at least one of colour component or colour format.

Clause 105. The method of clause 104, wherein the number of samples used to derive the IBC-LIC parameters for chroma components depends on colour format.

Clause 106. The method of clause 105, wherein the number of samples used for chroma components is same as luma component for 4:4:4 colour format.

Clause 107. The method of clause 105, wherein the number of samples used for chroma components is different from luma component for 4:4:4 colour format.

Clause 108. The method of clause 105, wherein the number of samples used for chroma components is different from luma component for 4:2:0/4:2:2 colour format.

Clause 109. The method of clause 105, wherein a minimum number of samples used to derive the IBC-LIC parameters for chroma components is same as luma component regardless of colour format.

Clause 110. The method of clause 104, wherein at least one parameter is not derived for a second component but inherited from a first component.

Clause 111. The method of clause 110, wherein the first component is Y component, and the second component is a chroma component.

Clause 112. The method of clause 104, wherein IBC-LIC parameters are derived individually for different components, or wherein at least one IBC-LIC parameter is shared by different components.

Clause 113. The method of clause 112, wherein the components comprise luma and chroma components.

Clause 114. The method of clause 112, wherein the components comprise chroma components.

Clause 115. The method of clause 104, wherein if a luma BV is used for chroma components, the luma BV is modified depending on the colour format.

Clause 116. The method of clause 115, wherein BV_{C}=BV_{L}(x>>(SubWidthC−1), y>>(SubHeightC−1)), or wherein BV_{C}=BV_{L}((x+1)>>(SubWidthC−1), (y+1)>>(SubHeightC−1)), or wherein BV_{C}=BV_{L}((x−1)>>(SubWidthC−1), (y−1)>>(SubHeightC−1)), or wherein BV_{C}=BV_{L}((x+1)>>(SubWidthC−1), (y−1)>>(SubHeightC−1)), or wherein BV_{C}=BV_{L}((x−1)>>(SubWidthC−1), (y+1)>>(SubHeightC−1)), and wherein BV_{L} represents the luma BV, BV_{C} represents a chroma BV, SubWidthC represents a subblock width, SubHeightC represents a subblock height, x represents a coordinate in horizontal direction, y represents a coordinate in a vertical direction.

Clause 117. The method of clause 116, wherein BV_{C} is used to derive a prediction of a chroma video unit.

Clause 118. The method of clause 116, wherein BV_{C} is used to derive a reference template used to derive IBC-LIC parameters for a chroma video unit.

Clause 119. The method of clause 118, wherein if BV_{C} is a fractional BV, BV_{C} is rounded to an integer BV.

Clause 120. The method of clause 119, wherein a clipping operation is used during rounding the fractional BV.

Clause 121. The method of clause 119, wherein the fractional BV is used to derive the reference template.

Clause 122. The method of clause 121, wherein an interpolation method used to derive the reference template is same as an interpolation method used to derive the prediction of the chroma video unit.

Clause 123. The method of clause 121, wherein an interpolation method used to derive the reference template is different as an interpolation method used to derive the prediction of the chroma video unit.

Clause 124. The method of clause 123, wherein the interpolation method used to derive the reference template and the interpolation method used to derive the prediction of the video unit have different interpolation taps.

Clause 125. The method of clause 124, wherein 2-tap interpolation filter is used to derive the reference template.

Clause 126. The method of any of clauses 1-125, wherein whether to and/or how to perform the compensation process to the prediction/reconstruction of the video unit using a model of the IBC-LIC depends on video characteristics.

Clause 127. The method of clause 126, wherein the video characteristics comprises at least one of: screen content, camera-captured content, natural content, or mixed content.

Clause 128. The method of clause 127, wherein one or more syntax elements are used to indicate whether the video unit belongs to which content.

Clause 129. The method of clause 127, wherein which content the video unit belongs to is determined adaptively.

Clause 130. The method of clause 129, wherein which content the video unit belongs to is determined using at least one of: neighboring reconstructed samples of the video unit, neighboring original samples, prediction samples of the video unit, original samples of the video unit, hash value, or one or more neighboring video units are coded with a mode.

Clause 131. The method of any of clauses 1-130, wherein the video unit is applied with other coding tools.

Clause 132. The method of clause 131, wherein the other coding tool comprises an inter prediction, or wherein the other coding tool comprises an intra prediction, or wherein the other coding tool comprises an in-loop filter.

Clause 133. The method of clause 132, wherein the inter prediction is A local illumination compensation (LIC), OR wherein the intra prediction comprises IntraTMP.

Clause 134. The method of any of clauses 1-133, wherein the video unit comprises at least one of: a color component, a prediction block (PB), a transform block (TB), a coding block (CB), a prediction unit (PU), a transform unit (TU), a coding tree block (CTB), a coding unit (CU), a coding tree unit (CTU), a CTU row, groups of CTU, a slice, a tile, a sub-picture, a block, a sub-region within a block, or a region containing more than one sample or pixel.

Clause 135. The method of any of clauses 1-134, wherein an indication of whether to and/or how to perform the compensation process to the prediction/reconstruction of the video unit using the model of the IBC-LIC is indicated at one of the followings: sequence level, group of pictures level, picture level, slice level, or tile group level.

Clause 136. The method of any of clauses 1-134, wherein an indication of whether to and/or how to perform the compensation process to the prediction/reconstruction of the video unit using the model of the IBC-LIC is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 137. The method of any of clauses 1-134, wherein an indication of whether to and/or how to perform the compensation process to the prediction/reconstruction of the video unit using the model of the IBC-LIC is indicated at one of the following: a PB, a TB, a CB, a PU, a TU, a CU, a VPDU, a CTU, a CTU row, a slice, a tile, a sub-picture, or a region contains more than one sample or pixel.

Clause 138. The method of any of clauses 1-134, wherein whether to and/or how to perform the compensation process to the prediction/reconstruction of the video unit using the model of the IBC-LIC is coded information of the video unit, and wherein the coded information comprises at least one of a block size, a colour format, a single tree partitioning, a dual tree partitioning, a colour component, a slice type, or a picture type.

Clause 139. The method of any of clauses 1-138, wherein the conversion includes encoding the video unit into the bitstream.

Clause 140. The method of any of clauses 1-138, wherein the conversion includes decoding the video unit from the bitstream.

Clause 141. An apparatus for video processing comprising a processor and a non-transitory memory with instructions thereon, wherein the instructions upon execution by the processor, cause the processor to perform a method in accordance with any of clauses 1-140.

Clause 142. A non-transitory computer-readable storage medium storing instructions that cause a processor to perform a method in accordance with any of clauses 1-140.

Clause 143. A non-transitory computer-readable recording medium storing a bitstream of a video which is generated by a method performed by an apparatus for video processing, wherein the method comprises: determining whether an intra block copy (IBC) and local illumination compensation (LIC) (IBC-LIC) is applied to a video unit of the video; in accordance with a determination that the IBC-LIC is applied to the video unit, performing a compensation process to a prediction/reconstruction of the video unit using a model of the IBC-LIC; and generating the bitstream based on the compensated prediction/reconstruction of the video unit.

Clause 144. A method for storing a bitstream of a video, comprising: determining whether an intra block copy (IBC) and local illumination compensation (LIC) (IBC-LIC) is applied to a video unit of the video; in accordance with a determination that the IBC-LIC is applied to the video unit, performing a compensation process to a prediction/reconstruction of the video unit using a model of the IBC-LIC; generating the bitstream based on the compensated prediction/reconstruction of the video unit; and storing the bitstream in a non-transitory computer-readable recording medium.

### Example Device

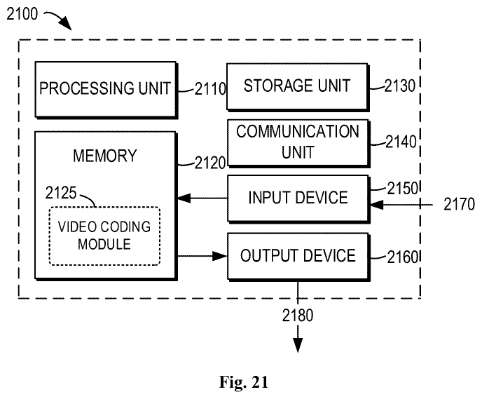

FIG. 21 illustrates a block diagram of a computing device 2100 in which various embodiments of the present disclosure can be implemented. The computing device 2100 may be implemented as or included in the source device 110 (or the video encoder 114 or 200) or the destination device 120 (or the video decoder 124 or 300).

It would be appreciated that the computing device 2100 shown in FIG. 21 is merely for purpose of illustration, without suggesting any limitation to the functions and scopes of the embodiments of the present disclosure in any manner.

As shown in FIG. 21, the computing device 2100 includes a general-purpose computing device 2100. The computing device 2100 may at least comprise one or more processors or processing units 2110, a memory 2120, a storage unit 2130, one or more communication units 2140, one or more input devices 2150, and one or more output devices 2160.

In some embodiments, the computing device 2100 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2100 can support any type of interface to a user (such as “wearable” circuitry and the like).

The processing unit 2110 may be a physical or virtual processor and can implement various processes based on programs stored in the memory 2120. In a multi-processor system, multiple processing units execute computer executable instructions in parallel so as to improve the parallel processing capability of the computing device 2100. The processing unit 2110 may also be referred to as a central processing unit (CPU), a microprocessor, a controller or a microcontroller.

The computing device 2100 typically includes various computer storage medium. Such medium can be any medium accessible by the computing device 2100, including, but not limited to, volatile and non-volatile medium, or detachable and non-detachable medium. The memory 2120 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2130 may be any detachable or non-detachable medium and may include a machine-readable medium such as a memory, flash memory drive, magnetic disk or another other media, which can be used for storing information and/or data and can be accessed in the computing device 2100.

The computing device 2100 may further include additional detachable/non-detachable, volatile/non-volatile memory medium. Although not shown in FIG. 21, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2140 communicates with a further computing device via the communication medium. In addition, the functions of the components in the computing device 2100 can be implemented by a single computing cluster or multiple computing machines that can communicate via communication connections. Therefore, the computing device 2100 can operate in a networked environment using a logical connection with one or more other servers, networked personal computers (PCs) or further general network nodes.

The input device 2150 may be one or more of a variety of input devices, such as a mouse, keyboard, tracking ball, voice-input device, and the like. The output device 2160 may be one or more of a variety of output devices, such as a display, loudspeaker, printer, and the like. By means of the communication unit 2140, the computing device 2100 can further communicate with one or more external devices (not shown) such as the storage devices and display device, with one or more devices enabling the user to interact with the computing device 2100, or any devices (such as a network card, a modem and the like) enabling the computing device 2100 to communicate with one or more other computing devices, if required. Such communication can be performed via input/output (I/O) interfaces (not shown).

In some embodiments, instead of being integrated in a single device, some or all components of the computing device 2100 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2100 may be used to implement video encoding/decoding in embodiments of the present disclosure. The memory 2120 may include one or more video coding modules 2125 having one or more program instructions. These modules are accessible and executable by the processing unit 2110 to perform the functionalities of the various embodiments described herein.

In the example embodiments of performing video encoding, the input device 2150 may receive video data as an input 2170 to be encoded. The video data may be processed, for example, by the video coding module 2125, to generate an encoded bitstream. The encoded bitstream may be provided via the output device 2160 as an output 2180.

In the example embodiments of performing video decoding, the input device 2150 may receive an encoded bitstream as the input 2170. The encoded bitstream may be processed, for example, by the video coding module 2125, to generate decoded video data. The decoded video data may be provided via the output device 2160 as the output 2180.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, for a conversion between a video unit of a video and a bitstream of the video, whether an intra block copy (IBC) and local illumination compensation (LIC) (IBC-LIC) is applied to the video unit;
in accordance with a determination that the IBC-LIC is applied to the video unit, performing a compensation process to a prediction/reconstruction of the video unit using a model of the IBC-LIC; and
performing the conversion based on the compensated prediction/reconstruction of the video unit.

2. The method of claim 1, wherein one or more offsets are used to modify one or more parameters of the model, and/or
wherein the model is presented as:
c₀×x₀+c₁×x₁+c₂×x₂+ . . . +c_{N}×x_{N}+B, and
wherein cᵢ represents a parameter and xᵢ represents coding information, i is an integer number and in a range from 0 to N, N is a predefined number, B represents a bias parameter which is derived together with cᵢ.

3. The method of claim 2, wherein the one or more offsets are indicated, or wherein the one or more offsets are derived, or wherein the one or more offsets are predefined, and/or
wherein whether to and/or a way to use the one or more offsets to modify the one or more parameters is indicated, or
wherein whether to and/or a way to use the one or more offsets to modify the one or more parameters is predefined, or
wherein whether to and/or a way to use the one or more offsets to modify the one or more parameters is determined based on coding information, and/or
wherein the coding information comprises at least one of: reconstruction samples, reference samples, prediction samples, values calculated using the reconstruction samples, values calculated using the reference samples, values calculated using the prediction samples, position information of the reconstruction samples, position information of the reference samples, or position information of the prediction samples.

4. The method of claim 1, wherein a current template comprising neighboring reconstructed samples of the video unit and a reference template are used to derive parameters of the model, and the reference template is derived using a block vector (BV) that is used to obtain the prediction of the video unit, and/or
wherein a way solving a model used for another coding tool is used to derive parameters of the model, and/or
wherein more than one way is used to derive parameters for IBC-LIC.

5. The method of claim 4, wherein if the BV is a fractional BV, the fractional BV is rounded to an integer BV, and/or
wherein the way is Gaussian elimination used in CCCM and a variant of Gaussian elimination, and/or
wherein which way is used to derive the parameters is indicated, or
wherein which way is used to derive the parameters is predefined, or
wherein which way is used to derive the parameters is determined based coding information.

6. The method of claim 1, wherein the IBC-LIC is used in a process of reordering a BV candidate list.

7. The method of claim 6, wherein two-pass reordering is used to reorder the BV candidate list.

8. The method of claim 7, wherein the IBC-LIC is applied in at least one of: a first pass reordering, or a second pass reordering.

9. The method of claim 1, wherein more than one LIC equation is used to compensate the prediction or reconstruction of the video unit, and parameters of the more than one LIC equations are derived using different templates.

10. The method of claim 9, wherein at least one of the following templates is used to derive the parameters:
left template,
above template,
left-above template,
left-below template, or
above-right template.

11. The method of claim 1, wherein more than one way is used to derive parameters for IBC-LIC.

12. The method of claim 11, wherein which way is used to derive the parameters is indicted, or
wherein which way is used to derive the parameters is predefined, or
wherein which way is used to derive the parameters is determined based on coding information.

13. The method of claim 1, wherein one or more of: at least one parameter in the model or at least one IBC-LIC model used for video units coded before a current video unit are used for the current video unit, and/or
wherein one or more of: at least one parameter in the model or at least one IBC-LIC model used for video units decoded before a current video unit are used for the current video unit, and/or
wherein the IBC-LIC is applied to sub-blocks within the video unit which is a current video unit.

14. The method of claim 1, wherein whether to and/or how to perform the compensation process to the prediction/reconstruction of the video unit using a model of the IBC-LIC depends on video characteristics, and/or
wherein the video unit is applied with other coding tools.

15. The method of claim 14, wherein the other coding tool comprises an inter prediction, or
wherein the other coding tool comprises an intra prediction, or
wherein the other coding tool comprises an in-loop filter.

16. The method of claim 15, wherein the inter prediction is A local illumination compensation (LIC), OR
wherein the intra prediction comprises IntraTMP.

17. The method of claim 1, wherein the conversion includes encoding the video unit into the bitstream, or
wherein the conversion includes decoding the video unit from the bitstream.

18. An apparatus for video processing comprising a processor and a non-transitory memory with instructions thereon, wherein the instructions upon execution by the processor, cause the processor to perform a method, wherein the method comprises:
determining, for a conversion between a video unit of a video and a bitstream of the video, whether an intra block copy (IBC) and local illumination compensation (LIC) (IBC-LIC) is applied to the video unit;
in accordance with a determination that the IBC-LIC is applied to the video unit, performing a compensation process to a prediction/reconstruction of the video unit using a model of the IBC-LIC; and
performing the conversion based on the compensated prediction/reconstruction of the video unit.

19. A non-transitory computer-readable storage medium storing instructions that cause a processor to perform a method, wherein the method comprises:
determining, for a conversion between a video unit of a video and a bitstream of the video, whether an intra block copy (IBC) and local illumination compensation (LIC) (IBC-LIC) is applied to the video unit;
in accordance with a determination that the IBC-LIC is applied to the video unit, performing a compensation process to a prediction/reconstruction of the video unit using a model of the IBC-LIC; and
performing the conversion based on the compensated prediction/reconstruction of the video unit.

20. A non-transitory computer-readable recording medium storing a bitstream of a video which is generated by a method performed by an apparatus for video processing, wherein the method comprises:
determining whether an intra block copy (IBC) and local illumination compensation (LIC) (IBC-LIC) is applied to a video unit of the video;
in accordance with a determination that the IBC-LIC is applied to the video unit, performing a compensation process to a prediction/reconstruction of the video unit using a model of the IBC-LIC; and
generating the bitstream based on the compensated prediction/reconstruction of the video unit.
